(19) United States
(12) Patent Application Publication
(10) Pub. No.: US 2025/0350889 A1
(43) Pub. Date: Nov. 13, 2025

(54) Audio Perception Tuning Flow

(71) Applicant: Sonitum Inc., Malibu, CA (US)

(72) Inventors: Lawrence Guterman, Studio City, CA (US); Dmitry Zhukov, San Francisco, CA (US); Jody Winzelberg, San Mateo, CA (US); Anuj Gujar, Woodland Hiills, CA (US)

(73) Assignee: Sonitum Inc., Malibu, CA (US)

(21) Appl. No.: 18/660,764

(22) Filed: May 10, 2024

(51) Int. Cl. H04R 25/00; G06F 3/16

(52) U.S. Cl. CPC H04R 25/505; G06F 3/165; H04R 25/558; H04R 2225/55

(57) ABSTRACT

A novel system and method for identifying and establishing personalized audio parameter settings for a person with hearing loss and/or certain listening preferences, without requiring a traditional audiogram or hearing test as a starting point. Instead, two new elements are combined: (1) A group of original sample profiles, and (2) An original tuning flow methodology and algorithm. The tuning flow methodology and algorithm includes a decision-tree conditional logic and structured series of questions that leverage a) the group of sample profiles, and b) new approaches to user interface interaction.

### FIELD OF TECHNOLOGY

This patent application relates generally to hearing assists, and more specifically to hearing assist systems and techniques that include personalized audio parameter settings for the user of the hearing assist device.

### BACKGROUND

The traditional method of generating a hearing profile in the hearing aid industry includes the patient undergoing a pure tone hearing test evaluation in which the minimum audible level at which they can auditorily perceive individual frequencies is measured. The levels are typically measured at frequencies that range from 250 Hz or 500 Hz, to 4000 Hz, 6000 Hz or 8000 Hz, including octaves in between, and, in some cases, half-octaves. The resultant “curve” that identifies the user's hearing acuity at each frequency is called an audiogram, and it contains the level in decibel units at which the patient can barely hear each frequency.

This data is then sent to a hearing aid manufacturer, which applies a pre-prescribed, generalized heuristic to map the audiogram decibel levels to an output parameter value in the hearing aid signal processor. When sound enters the patient's outer ear, it is first amplified on a per-frequency basis based on the audiogram “prescription” by the hearing aid, before being relayed through the eardrum to the middle and inner ear. This tuning constitutes the “first fit” setting for the patient. This method has been the standard approach for creating a “first fit” setting, for a person suffering from hearing loss, for nearly a century. (The audiometer—the device that measures pure tones—was invented in 1919. Hearing aid technology transitioned from analog to digital in the 1990's).

Often, the “first fit” of the hearing aid for the patient does not provide a sufficiently precise solution for good speech understanding. The patient typically visits the audiologist for a follow-up appointment, or multiple appointments, during which the audiologist may make educated guesses about the patient's hearing needs by inquiring about their listening experience while using the hearing aid in live, ambient listening situations, and making adjustments to the device accordingly. This method of follow up fine-tuning is based on experience and “hunch,” since the audiologist is not able to get “inside the patient's brain” to experience the effect the way the patient does. The audiologist may also use certain technologies (e.g., real ear measurements, “REM”) to measure how accurately the hearing aid output reflects the intended programming based on the audiogram.

### SUMMARY

Described herein are systems and techniques for audio perception tuning of hearing assists.

Clause 1. A system comprising: a database, configured to store a plurality of sample profiles; an input/output device configured to receive inputs from a user and provide, at least, audible outputs to the user; a user interface comprising a graphical user interface (GUI); a real-time tuning mechanism; a digital signal processing filter-bank; a processor; and a memory, configured to store instructions configured to cause the system to perform operations comprising: causing the GUI to display a request for first user input; receiving the first user input based on first user interaction with the GUI; determining, with the processor and based on the first user input, that the user is experiencing a first hearing loss type; selecting, from the database and based on the determination that the user is experiencing a first hearing loss type, a first sample profile to the user; providing, with the input/output device, the first sample profile to the user; causing the GUI to display instructions for tuning of the first sample profile; receiving a second user input based on second user interaction with the GUI; tuning, with the real-time tuning mechanism, the first sample profile based on the second user interaction; processing, with the digital signal processing filter-bank and according to the tuned first sample profile processed by the real-time tuning mechanism, audio for output to the user; and causing the input/output device to provide the tuned audio.

Clause 2. The system of clause 1, wherein the second user input comprises a modification of a macro parameter by the user.

Clause 3. The system of clause 2, wherein the tuning comprises, in response to the modification of the macro parameter by the user, adjustment of: equalization levels for one or more frequency bands; compression threshold values for one or more frequency bands; attack time and/or release time values for one or more frequency bands; ratio values for one or more frequency bands; an input gain value; and/or output gain values.

Clause 4. The system of clause 1, wherein the first hearing loss type is high frequency sloping hearing loss.

Clause 5. The system of clause 4, wherein the operations further comprise: selecting and providing, based on the determination that the user is experiencing the high frequency sloping hearing loss, a second sample profile to the user; causing the GUI to display a request for indication of preference between the first sample profile and the second sample profile; and receiving user feedback indicating a preference for the first sample profile.

Clause 6. The system of clause 5, wherein the operations further comprise: selecting and providing, based on the user feedback indicating the preference for the first sample profile, a third sample profile to the user; causing the GUI to display a request for indication of preference between the first sample profile and the third sample profile; and receiving user feedback indicating a preference for the first sample profile.

Clause 7. The system of clause 1, wherein the first hearing loss type is flat or reverse-sloping hearing loss.

Clause 8. The system of clause 7, wherein the tuning the first sample profile comprises: adjusting a boost amount of the first sample profile; adjusting a sharp amount of the first sample profile; causing the GUI to display a request for indication of a sharp adjustment amount; and receiving a third user input indicating the sharp adjustment amount.

Clause 9. The system of clause 8, wherein the third user input indicates that the sharp adjustment amount is 50% or less, and wherein the tuning the first sample profile further comprises: adjusting a rich amount.

Clause 10. The system of clause 8, wherein the third user input indicates that the sharp adjustment amount is 50% or more, and wherein the operations further comprise: determining, based on the tuning of the first sample profile, that the user has high frequency sloping hearing loss.

Clause 11. A method comprising: causing a user interface comprising a graphical user interface (GUI) to display a request for first user input; receiving the first user input based on first user interaction with the GUI; determining, with a processor and based on the first user input, that the user is experiencing a first hearing loss type; selecting, from a database and based on the determination that the user is experiencing a first hearing loss type, a first sample profile to the user; providing, with an input/output device, the first sample profile to the user; causing the GUI to display instructions for tuning of the first sample profile; receiving a second user input based on second user interaction with the GUI; tuning, with a real-time tuning mechanism, the first sample profile based on the second user interaction; processing, with a digital signal processing filter-bank and according to the tuned first sample profile processed by the real-time tuning mechanism, audio for output to the user; and causing the input/output device to provide the tuned audio.

Clause 12. The method of clause 11, wherein the second user input comprises a modification of a macro parameter by the user.

Clause 13. The method of clause 11, wherein the tuning comprises, in response to the modification of the macro parameter by the user, adjustment of: equalization levels for one or more frequency bands; compression threshold values for one or more frequency bands; attack time and/or release time values for one or more frequency bands; ratio values for one or more frequency bands; an input gain value; and/or output gain values.

Clause 14. The method of clause 11, wherein the first hearing loss type is high frequency sloping hearing loss.

Clause 15. The method of clause 14, further comprising: selecting and providing, based on the determination that the user is experiencing the high frequency sloping hearing loss, a second sample profile to the user; causing the GUI to display a request for indication of preference between the first sample profile and the second sample profile; and receiving user feedback indicating a preference for the first sample profile.

Clause 16. The method of clause 15, further comprising: selecting and providing, based on the user feedback indicating the preference for the first sample profile, a third sample profile to the user; causing the GUI to display a request for indication of preference between the first sample profile and the third sample profile; and receiving user feedback indicating a preference for the first sample profile.

Clause 17. The method of clause 11, wherein the first hearing loss type is flat or reverse-sloping hearing loss.

Clause 18. The method of clause 17, wherein the tuning the first sample profile comprises: adjusting a boost amount of the first sample profile; adjusting a sharp amount of the first sample profile; causing the GUI to display a request for indication of a sharp adjustment amount; and receiving a third user input indicating the sharp adjustment amount.

Clause 19. The method of clause 18, wherein the third user input indicates that the sharp adjustment amount is 50% or less, and wherein the tuning the first sample profile further comprises: adjusting a rich amount.

Clause 20. The method of clause 18, wherein the third user input indicates that the sharp adjustment amount is 50% or more, and further comprising: determining, based on the tuning of the first sample profile, that the user has high frequency sloping hearing loss.

These and other embodiments are described further below with reference to the figures.

### BRIEF DESCRIPTION OF THE DRAWINGS

The included drawings are for illustrative purposes and serve only to provide examples of possible structures and operations for the disclosed inventive systems, apparatus, methods, and computer program products for audio perception tuning of hearing assists. These drawings in no way limit any changes in form and detail that may be made by one skilled in the art without departing from the spirit and scope of the disclosed implementations.

FIG. 1 is an overview of an audio perception tuning technique, in accordance with certain embodiments.

FIGS. 2 and 3 are block diagrams illustrating components for audio perception tuning, in accordance with certain embodiments.

FIGS. 4-8A and 9-19B are flow charts illustrating certain aspects of audio perception tuning, in accordance with certain embodiments.

FIG. 8B illustrates graphical user interfaces (GUIs) for selecting user profiles, in accordance with certain embodiments.

FIG. 20 is a block diagram illustrating an audio perception tuning system, in accordance with certain embodiments.

FIG. 21 is a block diagram illustrating certain aspects of an audio perception tuning system, in accordance with certain embodiments.

FIG. 22 illustrates a block diagram of an example computing system, in accordance with some embodiments.

### DETAILED DESCRIPTION

### Introduction

In the following description, numerous specific details are outlined to provide a thorough understanding of the presented concepts. The presented concepts may be practiced without some or all of these specific details. In other instances, well-known process operations have not been described in detail to not unnecessarily obscure the described concepts. While some concepts will be described in conjunction with the specific embodiments, it will be understood that these embodiments are not intended to be limiting.

It is appreciated that, for the purposes of this disclosure, when an element includes a plurality of similar elements distinguished by a letter or follow-on numeral following the ordinal indicator (e.g., “236A” and “236B” or “236-1” and “236-2”) and reference is made to only the ordinal indicator itself (e.g., “236”), such a reference is applicable to all the similar elements.

Described herein are systems and techniques for audio perception tuning of hearing assist devices. Such systems and techniques can include hearing aids, software hearing assists for use with electronic devices (e.g., earbuds, headphones, smartphones, computers, and/or other such devices), and/or other such devices. Thus, the hearing assist devices may be implemented through any combination of hardware and software, including offered as software for use with a user's personal electronic device, such as their smartphone. Accordingly, as described herein, a personalized profile may be determined and provided to a user device, and such profile may then process sounds received by the device before outputting the processed sound to the user.

In various embodiments, the systems and techniques described herein may include a hearing assessment, which can be taken by users on a user device (e.g., mobile phone), whose results have been shown to be not statistically significantly different from a clinical audiogram. Audiogram data is provided that are associated with a plurality of subjects, including minimum thresholds and “discomfort levels” (e.g., the level of output, such as frequency or amplitude of the output, that cause discomfort to the user, such as physical discomfort including pain) used to establish the dynamic range of hearing, across a wide frequency spectrum. Discomfort level information may help target a speech response more accurately than minimum threshold information alone as, in addition to having a lesser ability to perceive soft sounds, hearing loss sufferers often have a lower tolerance for loud sounds that is frequency-dependent. This is known as hyperacusis. This discomfort level information informs Wide Dynamic Range Compression (“WDRC”) parameters in a DSP Filter-bank. Such parameters include those related to compression thresholds, and time constants, such as attack time and release time of a digital signal processor (DSP) filter bank. The system and techniques described herein include a focus on a subjects' discomfort levels, in contrast to typical techniques utilized by a hearing dispensary or audiology practice.

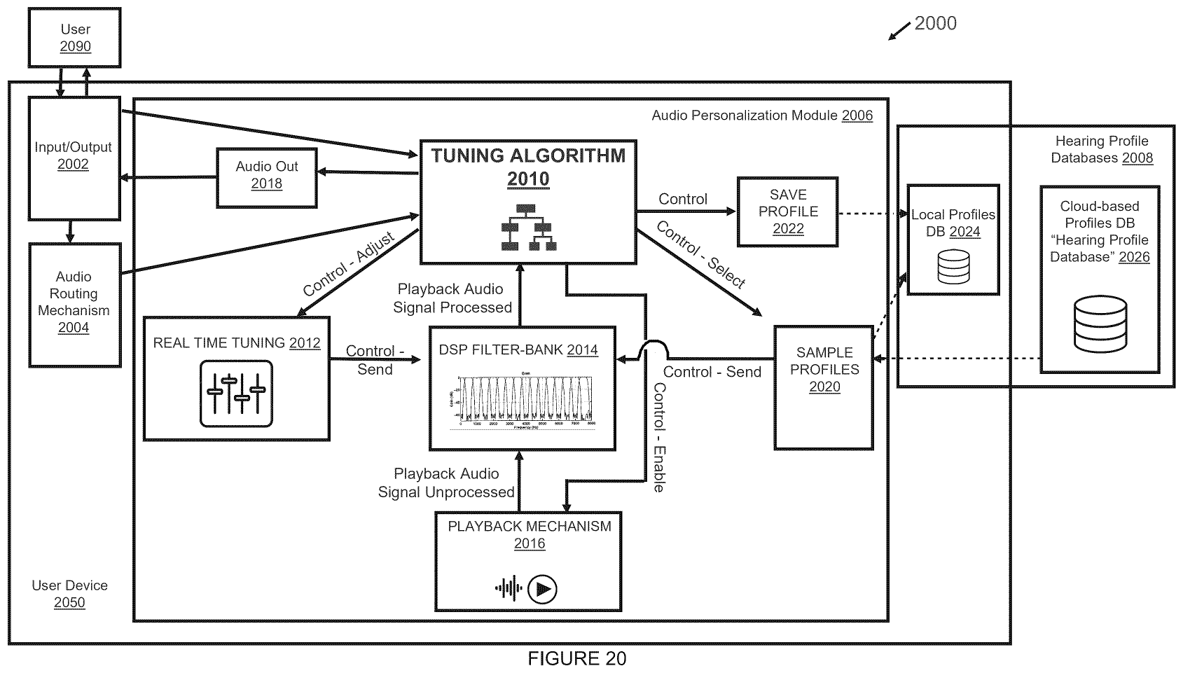

As described herein, “compression threshold” may refer to the decibel level per frequency at which the listener experiences discomfort when listening to a presented audio stimulus such as a pure tone. The DSP filter bank, which may provide the processed audio to a user, as described in FIG. 20, uses the compression threshold parameter value to “compress” an audio signal at the given frequency band or collection of frequencies, so that the output signal does not substantially (e.g., within 50% or less, 25% or less, 10% or less, or 0%) exceed the compression threshold at that given frequency or for that given collection of frequencies.

“Attack time” may be an example of a time constant. Attack time may be a parameter that is the rate at which the compression is applied at a given frequency or collection of frequencies, to the beginning of the phoneme, often called the “transient,” which might also be referred to as the onset of the phoneme or speech sound. A faster attack time means the compression is applied more aggressively (e.g., is more aggressively applied on the transient), and a slower attack time means that compression is applied more slowly. “Release time” refers to the rate at which the compression “tapers off” or “decays” at the end of a word or phoneme.

“Equalization gains” may be the gains to decibel level applied by the DSP filter bank per frequency in order to enable a listener with hearing deficiency at a certain frequency or frequencies to perceive/hear an audio signal at that frequency or frequencies. “Ratio” may refer to the mathematical aggressiveness with which the compression of the signal is applied once the signal decibel level hits the compression threshold. Ratio may differ from attack time in that ratio refers to the aggressiveness of the decibel level “clamping” versus the rate of the application of the compression for a given transient or phoneme onset.

The system and techniques described herein also include further user controls that allow a user or subject to listen to audio processed by their audiogram-generated hearing profile and refine the profile through the interfaces and systems described herein. As utilized herein, “user” or “subject” may both refer to an individual that is utilizing the hearing assist devices described herein. Users can adjust make adjustments to letters and phonemes, utilizing the user interface and techniques described in U.S. Pat. No. 9,933,990, entitled “Topological Mapping of Control Parameters” which is hereby incorporated by reference in its entirety for all purposes. These letters and phonemes are associated with underlying frequencies, couplings of frequencies, and modulated frequency envelopes. This methodology allows users to “zero in” on their hearing profile to obtain more precisely targeted response curves for better speech understanding. The parameters involved include the full gamut of wide dynamic range compression parameters, including equalization gains, compression thresholds, attack time, release time, ratio, and other such parameters. The resultant hearing profiles generated by an iterative feedback approach where the users themselves are empowered by being able to listen to audio while making adjustments, represent a revolutionary leap beyond prior methods as, previously, the audiologist had to infer what the user was hearing by asking questions, since the audiologist could not “get inside the user's brain.”

Despite the above improvements in the acquisition of a user's audiological data, some users are still not getting sufficiently optimized correction for their hearing loss or listening preferences. The process of taking the hearing test can be time-consuming and may result in errors. For the employee or user in enterprise, academia, or other setting who may require quick setup, the process can be inefficient and a barrier to adoption. Hence, there is a need to speed up the onboarding process. Furthermore, security-related concerns in enterprise and academia may make cloud-based storage of hearing test data problematic.

Described herein are systems and techniques for generating hearing profiles for the user. The systems and techniques described herein: a) provide preset sample profiles additional or alternative to administration of a hearing test; and b) provide comprehensive guidance regarding the order in which to make adjustments based on answers provided by the user to iterative questions presented to the user. The systems and techniques described herein provide a novel guided self/fine-tuning algorithm on top of sample profiles in order to match or supersede the efficacy of a hearing test-based profile in a process that is more efficient than traditional processes.

By analyzing a large database of self-tuned profiles using its deep domain knowledge, a plurality of sample profiles, which provide a relevant, optimized “ballpark” processing for the range of hearing loss from mild to severe-profound, are utilized as possible base profiles. A user can select the sample profile, from among the plurality of possible sample profiles, that comes closest to providing good speech understanding, and further provide fine-tuning adjustments to “dial in” superior speech understanding, utilizing the systems and techniques described herein.

For users with more severe hearing loss, especially hearing loss with severely sloping configurations in which there is a large delta in minimum threshold decibel levels between different frequencies, this allows sculpting ever more precise compensation curves for the wide dynamic range compression parameters including gains, and compression thresholds, to attain a precise result.

Unlike traditional techniques, the techniques described herein enables a user to generate a more accurate and precisely targeted hearing profile tailored to their listening ability and/or listening preferences, for the purpose of achieving, among other things, improved speech understanding, better perceived sound quality, better perceived appreciation of music, and more. As described above, for users with more severe hearing loss, and/or hearing loss with severely sloping configurations, the ability to surgically sculpt ever more precise and granular compensation curves is enabled by leveraging the interactive refinement capability described herein. The interactive refinement capability can be iterative, recursive, or both.

The systems and techniques described herein provide a user a guided, decision-tree structured, stepwise and largely non-commutative process as an effective alternative to, and possible improvement on, a pure tone hearing test that generates a first fit, followed by possible multiple fine-tuning visits to the audiologist. Additionally, security-related concerns in enterprise and academia may be mitigated by local processing of audio on a device using local sample profiles and tuning algorithms.

### Tuning System

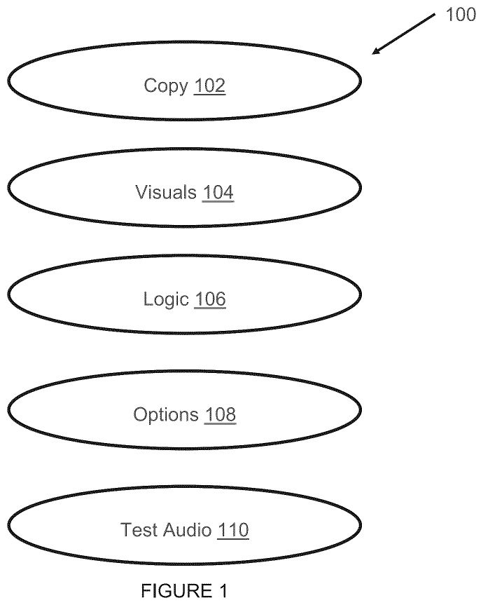

FIG. 1 is an overview of an audio perception tuning technique, in accordance with certain embodiments. FIG. 1 illustrates elements 100 of an audio perception tuning technique. Elements 100 may include copy 102, visuals 104, logic 106, options 108, and test audio 110. Elements 100 may be items of the system that interact with a user, for audio perception tuning.

Copy 102 includes items displayed to the user, such as instructional text for the user. Visuals 104, which may accompany copy 102, may provide clarification of copy 102. For example, visuals 104 may include images, drawings, symbols, and any other visual indicator that clarifies the instructions in copy 102. Logic 106 may include algorithms such as decision tree flows and conditional navigation functionality, including nodes and branches, that, for example, determine follow-ups to user responses. Such algorithms are further described herein. Options 108 may include answers for copy 102, including answers such as affirmative, negative, “I don't know,” or multiple-choice answers, user inputs, and/or other such possible answers. Such answers may be provided as an input to logic 106. Test audio 110 may include spoken audio clips provided for self-tuning purposes. Such audio clips may, for example, feature a range of vocal use cases, such as use cases that include one or more male voices, one or more female voices, and/or other such sounds.

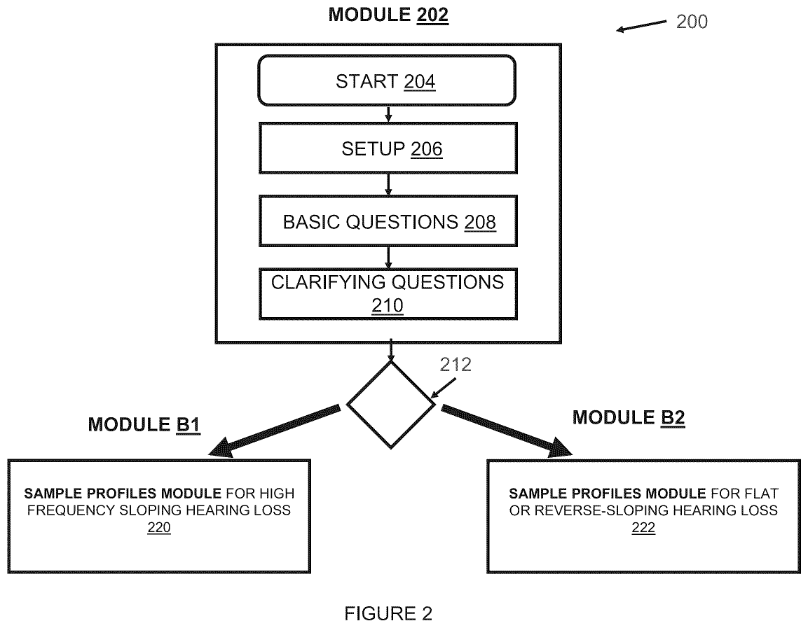

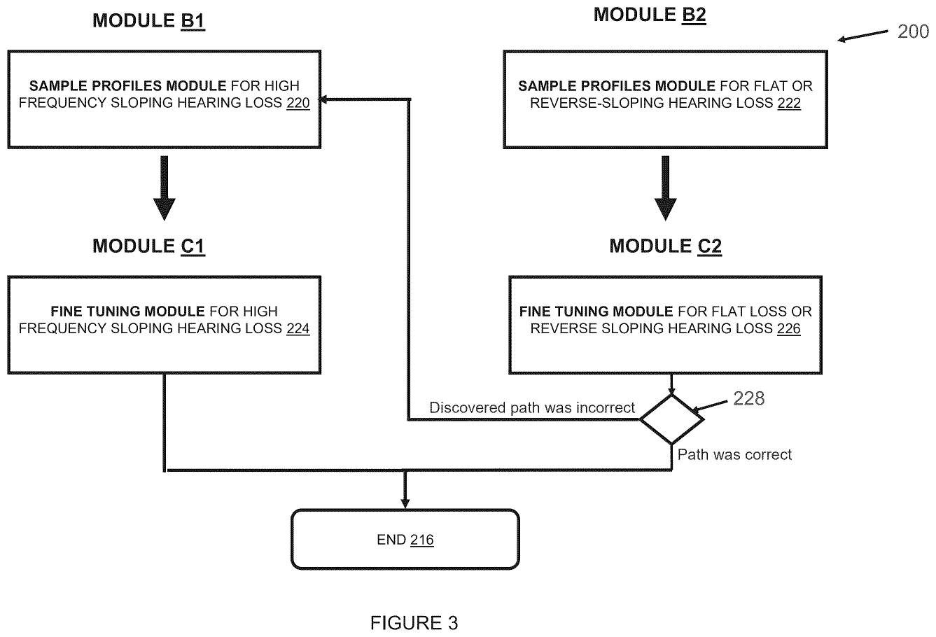

FIGS. 2 and 3 are block diagrams illustrating components for audio perception tuning, in accordance with certain embodiments. FIGS. 2 and 3 illustrate various system modules for implementing the algorithms described herein. Specifically, the elements of FIG. 2 are continued in FIG. 3. FIGS. 2 and 3 illustrate system 200 that includes a plurality of modules that may be the high-level steps of a decision tree algorithm for implementing the techniques described herein.

System 200 may include module 202, which may include start module 204, setup module 206, basic questions module 208, and clarifying questions module 210, which are further described herein. System 200 may additionally include Sample Profiles Step-Through Module B, which may include module B1 that includes High Frequency Sloping Loss Sample Profiles Module 220, and module B2, Flat or Reverse Sloping Loss Sample profiles Module 222. System 200 may further include Fine Tuning Module C, which may include module C1, High Frequency Sloping Loss Fine Tuning Module 224, and module C2, Flat or Reverse-Sloping Loss Fine Tuning Module 226.

The technique described herein utilizes the various modules to perform audio perception tuning. For example, after initially onboarding a user through the portions of module 202, the technique proceeds to Module B. When proceeding to Module B, a determination may be made by a processor in 212 as to whether to proceed to Module B1 or B2. The processor may select Module B1 if a determination is made (e.g., by Module 202) that the user is suffering from high frequency sloping loss and may select Module B2 if a determination is made that the user is suffering from flat or reverse sloping loss.

From Module B, the technique may then proceed to Module C. Techniques utilizing Module B1 may proceed to Module C1 while techniques utilizing Module B2 may proceed to Module C2. After performing the techniques of Module C1, the technique may finish in 216.

In certain situations, high frequency sloping loss may be incorrectly determined as flat or reverse sloping loss. After performing the technique for flat or reverse sloping loss, a determination may be made by the processor in 228 as to whether the discovered path was correct or incorrect. If incorrect, the technique may proceed to Module B1 for high frequency sloping loss. Otherwise, the technique may finish in 216.

System 200 allows for audio perception tuning through a technique that provides users with a carefully curated and directed journey to aid users in the process of obtaining increasingly optimized results for improving their understanding of speech in light of their particular hearing loss, or for improving perceived sound quality based on their listening preferences. System 200 is configured to provide a multi-branch, decision-tree algorithm may include a correctness checkpoint 228 that allows users to take “backward steps” in the event the path the user is heading down is determined to be the incorrect one to optimize speech discrimination for their specific hearing loss. The algorithm also includes comparator components in which the user will “toggle” between profiles and be asked to compare the results, iteratively.

### Audio Perception Tuning Examples

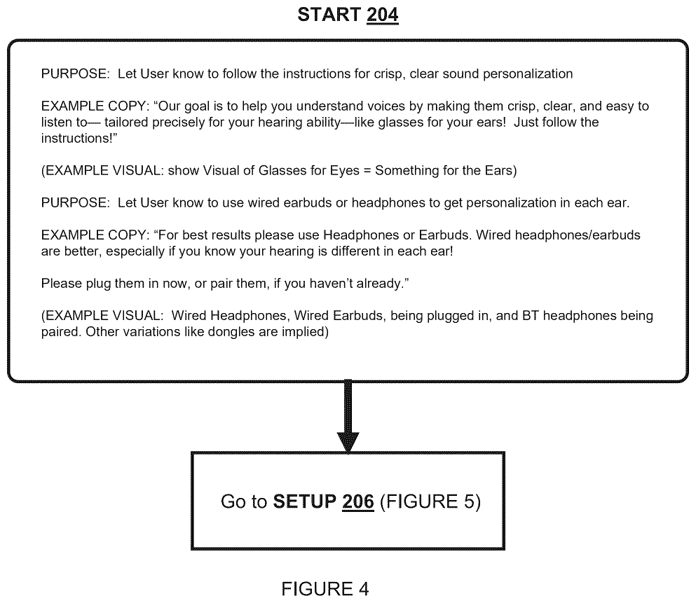

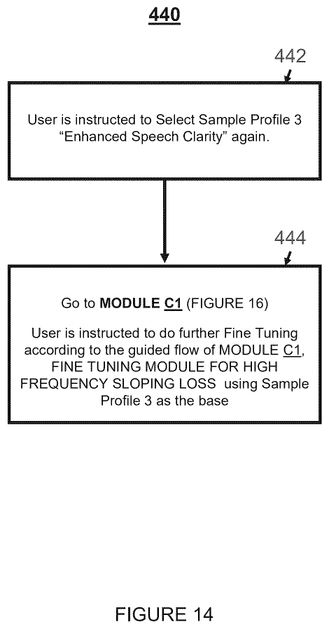

FIGS. 4-8A and 9-19B are flow charts illustrating certain aspects of audio perception tuning, in accordance with certain embodiments.

With reference to FIG. 4, start module 204 may display a copy that may explain the goal of the process to a user. Thus, start module 204 may be configured so that the copy can be text presented to the user (e.g., on a display screen of a user device such as a smart phone, computer, tablet, or other electronic device) to inform the user of the goal of audio perception tuning (e.g., to help the user understand voices by making them crisp, clear, and easy to listen to and tailored precisely for their hearing ability, similar to “glasses for their ears”). The user may additionally be informed to follow the forthcoming instructions.

By way of example only, the copy may include instructions directed toward headphone use. Such instructions may instruct users on, for example, the benefit of wired headphones. The copy, which may be presented in text on a display of the user device and/or on stereo audio for asymmetric hearing loss, when utilized by start module 204, may instruct the user that for best results, the user should use headphones or earbuds.

The copy may also indicate that wired headphones/earbuds are preferable, especially if they know their hearing is different in each ear, as wired headphones will provide “true stereo,” i.e., a distinct, processed audio signal for each ear. This is important because many people have asymmetric hearing loss, i.e., different hearing capability in each ear. Bluetooth headphones on a 2-way communications session (e.g.: video conference call) blend the left and right audio signals as Bluetooth compression algorithms sometimes do not have wide enough bandwidth to support stereo audio.

Moreover, Bluetooth-connected headsets employ compression codecs to transmit the audio signal, which generally diminishes or “crushes” the signal compared a wired connection, whereas people with hearing loss will generally benefit from a wider bandwidth signal that contains as much of the original sound information as possible.

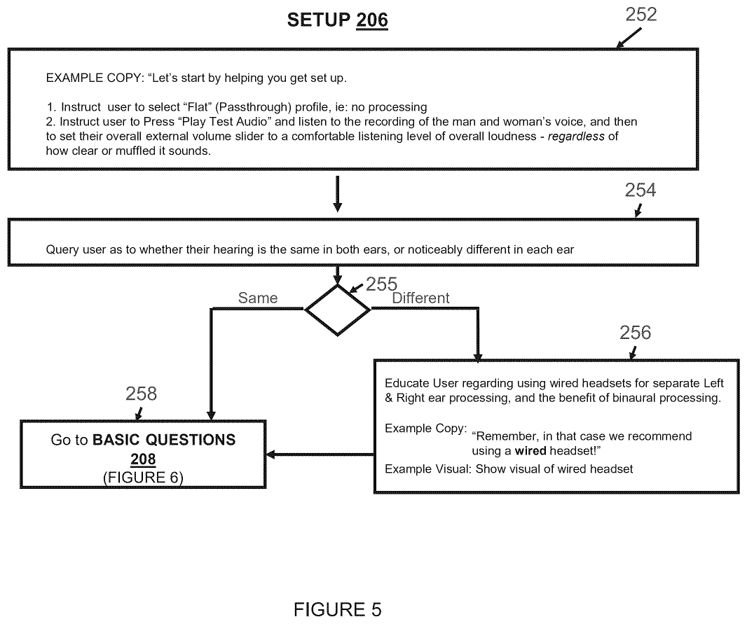

With reference to FIG. 5, setup module 206 allows a user to establish proper settings for the headphones or other audio output device utilized by the user. For example, the user can establish comfortable listening levels and provide information on whether their hearing is symmetric or asymmetric.

In 252, setup module 206 may allow for establishment of comfortable listening levels. To establish comfortable listening levels, the user may be instructed to select the “Flat” (Passthrough) profile. The Flat profile allows regular audio from the user device to pass unprocessed through to the output (e.g., speakers) of the user device. The user may then be instructed to “Play Test Audio” and listen to various sounds, such as a man's voice and/or a woman's voice, and set the overall volume of the output (the output volume of the user device after any, all, or no processing has been applied to the audio signal) to a “comfortable listening level of overall loudness, regardless of how clear or muffled it sounds.” Such a comfortable listening level may be based on the user's judgment. That is, the output may be set by the user to a comfortable level by, for example, changing the volume of the output through a volume slider or other technique for manipulation of volume of the user device. In 252, setup module 206 may emphasize to the user that compensating for hearing loss has more to do with enhancing clarity and less to do with turning up the volume of the sound. Thus, setup module 206 is only a portion of the process.

In 254, setup module 206 may determine whether a user has symmetric or asymmetric hearing. Thus 254 may query the user as to whether their hearing is the same in both ears or noticeably different. A user may provide certain responses to the query, such as one or more of (1) Same in both ears; (2) Noticeably different in each ear. Based on the response, a determination may be made in 255 as to whether to continue immediately to basic question module 208 (if the response is the same in both ears) or educate/remind the user as to why a wired headset is recommended before proceeding to basic question module 208 (if the response is noticeably different in each ear).

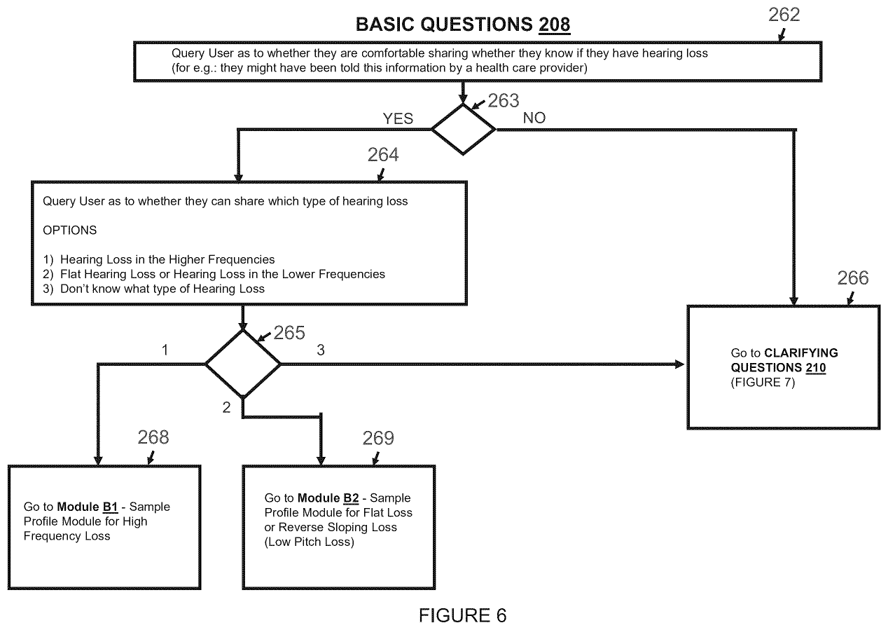

With reference to FIG. 6, basic question module 208 may, in 262, query the user as to whether they are comfortable sharing whether they know if they have hearing loss. Their response may be provided in 263 (e.g., from a user interface of the user device) and, if they indicate that they are comfortable providing it, they can be asked, in 264 if they already know, for example, from a health care provider such as an audiologist or ear, nose and throat doctor, whether they have hearing loss, and, if so, whether they know what type of hearing loss they have.

Such queries may be useful as people with high frequency loss tend to be “aware” of sound but often cannot discriminate between phonemes, which means that they cannot understand speech well, since, in English and Western languages, much of the speech understanding information comes from high frequency phonemes such as the consonants and sibilants, e.g., k's, t's, sh's, s's, f's, th's, etc. 80% of people with the most common form of progressive sensorineural hearing loss suffer from high frequency hearing loss. This is also associated with more trouble understanding women and children's voices, since the fundamental frequency of those voices is higher than men's voices. People with hearing loss in low pitches (“reverse sloping loss”) tend to have difficulty with men's deeper voices, and if they have “flat” loss across all frequencies, they may simply have trouble with awareness of sound, regardless of clarity.

An example methodology flow of basic question module 208 may be as follows. A first question, in 262 may query the user “Are you comfortable sharing whether you know if you have hearing loss?” Response options may be “yes” or “no” in 263.

If yes, basic question module 208 may proceed to 264 and may provide a further query of, “Can you tell us a little bit more about your hearing abilities?” The user may provide various responses to the “type of hearing loss” query in 264, including indicating that they have hearing loss in the higher pitches, hearing loss in the lower pitches or flat hearing loss, or that they do not know what type of loss they have. Thus, response options, provided by the user in 265, may include: (1) Trouble hearing higher pitches (frequencies); (2) Hearing loss in the lower pitches (frequencies), OR “flat” hearing loss; (3) I don't know what type of hearing loss I have.

If the response in 265 is (1), basic question module 208 may proceed to 268 and, thus, proceed to module B1. If the response in 265 is (2), basic question module 208 may proceed to 269 and, thus, proceed to module B2. If the response in 265 is (3) or if the response in 263 is “no”, basic question module 208 may proceed to 266 and, thus, proceed to clarifying questions 210.

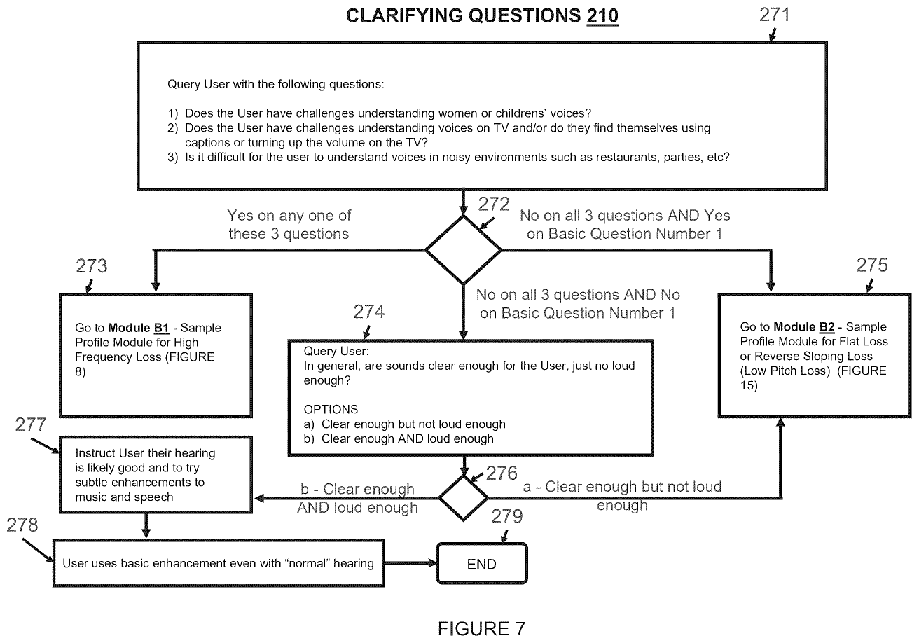

With reference to FIG. 7, the processor of the user device may access clarifying questions module 210 if a determination is made that the user does not know what type of hearing loss the user possesses. Clarifying questions module 210 may provide further divining questions to try to establish the type of hearing loss.

By way of example only, in 271, clarifying questions module 210 may provide the following queries to the user:
(1) Do you have challenges understanding women or children's voices? Potential answers may be “yes” or “no.”
(2) Do you sometimes have a difficult time understanding voices on television (TV) and/or do you find yourself turning the volume up or using captions? Potential answers may be “yes” or “no.”
(3) Is it difficult for you to understand others in restaurants? Potential answers may be “yes” or “no.”

For example, if the user answers “yes” to either questions (1) or (2), a determination may be made by the processor that the user may have high frequency loss, with fair confidence. The fundamental frequency of women and children's voices is higher than men's. A principle of acoustical physics means that high frequencies of sound coming from a sound source through the air diminish more rapidly than low frequencies, which in turn means that it is potentially harder for people with high frequency hearing loss to understand dialogue from a television show or movie, than people with a “normal” hearing response.

If the user answers “no” to questions (1) and/or (2) and answers “yes” to question 3, this implies that although they do not perceive hearing loss per se with women or children's voices or while listening to the TV, they may have “hidden hearing loss,” a condition which often presents as “normal” hearing on the audiogram, but means that they may have more difficulty hearing speech in background noise than someone with truly “normal” hearing. Hidden hearing loss may be treated by providing mild high frequency enhancement to allow the listener to “pull forward” some of the higher pitches of the “close” voice (e.g., the dinner partner at the restaurant) relative to the background voices, which tend to be more distant, and hence of lower frequency composition.

Clarifying questions module 210 may determine the next step in 272. Thus, for example, if the user answers “yes” to any one of the three questions in 271, the technique may proceed to Module B1 (Sample Profiled Module for High Frequency Loss) in 273. If the user answers “no” to all three questions in 271 and “yes” to (1) for basic question module 208 (whether the user has hearing loss in higher frequencies), the technique may proceed to Module B2 (Sample Profile Module for Low Frequency or Flat Loss) in 275. In such a situation, the user has acknowledged hearing loss and, if the hearing loss is not high frequency loss, it is likely low frequency or flat loss. If the user answers “no” to all three questions in 271 and to whether they are willing to acknowledge they have hearing loss (“no” on (1) for basic question module), then the application has no way to know if they have any hearing loss, and must query further by continuing to 274.

If the user indicates that they do not have issues with women and children's voice, do not have trouble understanding TV dialogue, nor have trouble understanding voices in noisy environments, and they answer “no” to sharing whether they know whether they have hearing loss, then 274 checks for low frequency or flat loss. If the user had answered “yes” to the questions about women and children's voices and/or to the TV in 271, the user would likely have high frequency loss.

274 may provide the following example copy: “In general, are sounds clear enough for you, just not loud enough?” Response options may include (a) “clear enough but not loud enough” or (b) “clear enough and loud enough.” If the response, in 276, is (a), then the technique may proceed to 275, Module B2 “Sample Profile Module for Low Frequency and Flat Loss.” If the user answers (b) “clear enough and loud enough” then they likely do not suffer from traditional hearing loss and they may be informed, “Your hearing is likely good. Try subtle adjustments to enhance music and speech” in 277. The user may then use subtle enhancements in 278 and may end in 279.

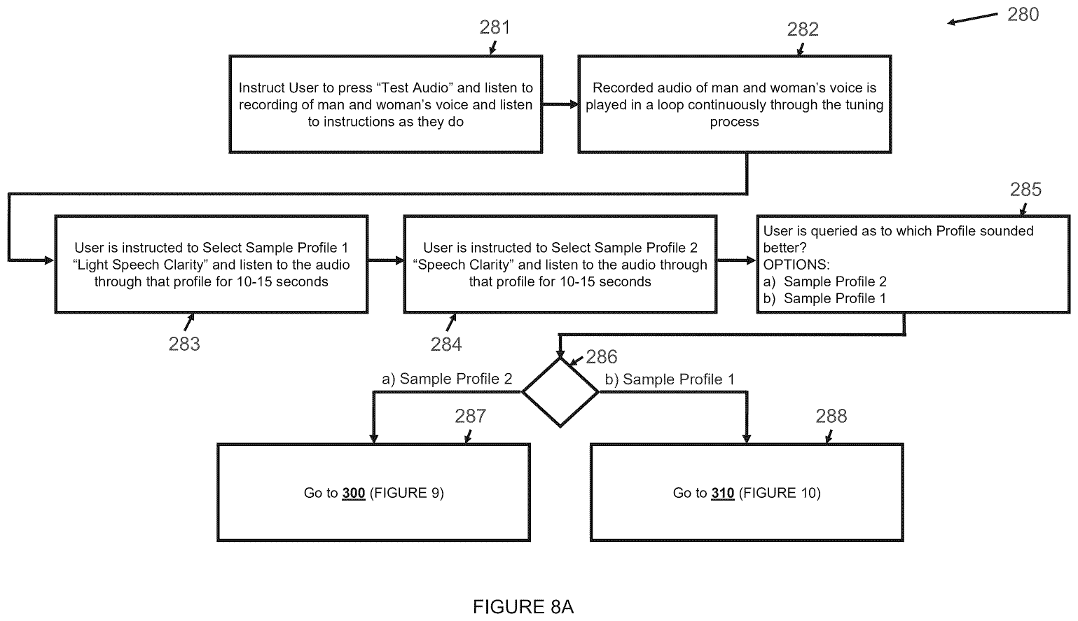

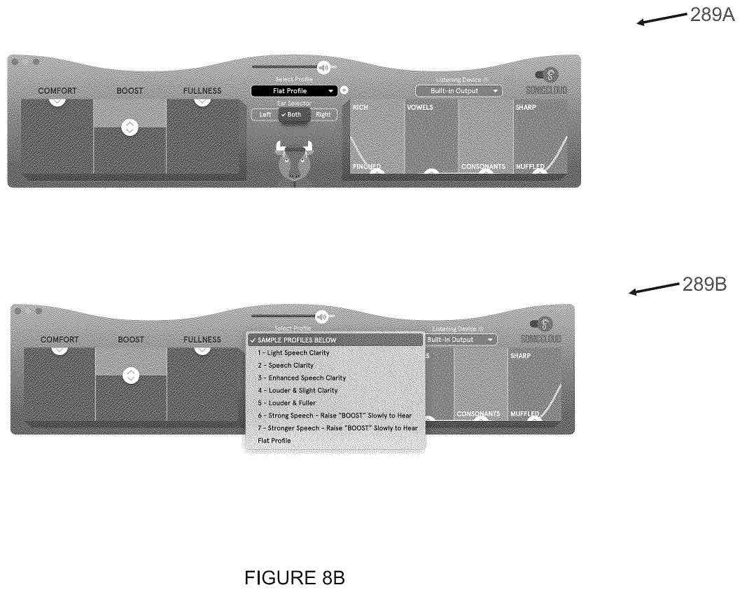

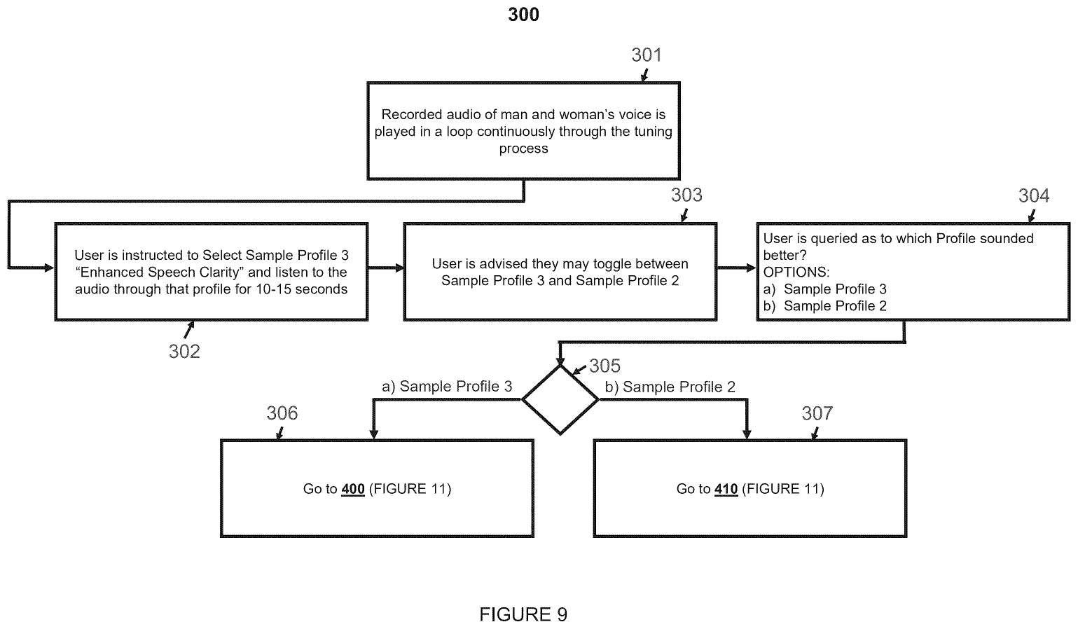

FIG. 8A (as well as FIGS. 9 to 14) may illustrate Module B1 (Sample Profiles Module for High Frequency Sloping Loss). If the processor, through logic 106, flows to Module B1, the user may then be progressed through a guided monotonic progression of test audios (e.g., test audios 110) or sample hearing profiles designed for addressing high frequency hearing loss, from mild, to light moderate, to moderate, to moderately severe, to severe and severe-to-profound loss.

Module B1 allows for the determination of a “ballpark” sample profile that yields hearing improvement as perceived by the user (e.g., appeals to the user's listening preferences) by using a comparative methodology similar to the optometrist's methodology: “Is this better, is that better?” At each step of the way, the user can go backwards if they find the enhancement they receive is better with a less aggressive sample profile.

In certain embodiments, various sample profiles may be determined from domain knowledge based on review of thousands of hearing profiles (e.g., acquired via users taking hearing tests and making self-tuning adjustments based on listening preferences). In certain embodiments, a limited number of sample profiles may be provided, to reduce complexity and data storage requirements. Thus, for example, three to eleven sample profiles may be provided. The sample profiles may include carefully selected wide-dynamic range compression parameter settings for more than 100 parameters, and allow the user with no knowledge of the science of sound or audio to zero in quickly on a “ballpark” profile that provides them with improved sound enhancement.

Such parameters may include, for example one or more of gain settings (e.g., for 5-20 different frequency bands) per ear, one or more of compression threshold settings (e.g., for 5-20 different frequency bands) per ear, one or more of attack time settings (e.g., for 5-20 different frequency bands) per ear, one or more of release time settings (e.g., for 5-20 different frequency bands) per ear, one or more of ratio settings (e.g., for 5-20 frequency bands) per ear, one or more of knee point settings (e.g., for 5-20 frequency bands) per ear.

In 281, the user may be instructed to press “Test Audio” and listen to a plurality of recordings (e.g., recordings that include a man's voice and a woman's voice and to listen to instructions within the recordings). In 282, the recordings may be played via a passthrough, unprocessed profile. The recordings may continue to play in a continuous loop during the tuning process.

In 283, the user may be instructed to select a first sample profile and listen to audio through that profile for a certain amount of time (e.g., 5-30 seconds). Such a sample profile may be directed to “Light Speech Clarity” and may be the most mild, high frequency enhanced hearing profile, intended for people with very light, or subtle high frequency hearing loss, or subtle hidden hearing loss.

In 284, the user may be instructed to select a second sample profile and listen to audio through that profile for a certain amount of time (e.g., 5-30 seconds). Such a sample profile may be directed to “Speech Clarity,” The profile presented in 283 may be milder than the profile presented in 284.

In 285, the user may be queried for feedback as to their preferences between the different profiles. Additionally or alternatively, the user may be queried for their opinion on each profile (e.g., “Does Profile 2 sound clear and comfortable? Or is it too shrill or sharp?”) The user may provide such feedback in 286, which may expressly provide a preference for one profile or may provide implied preference for one profile (e.g., by indicating that Profile 2 is too shrill or sharp).

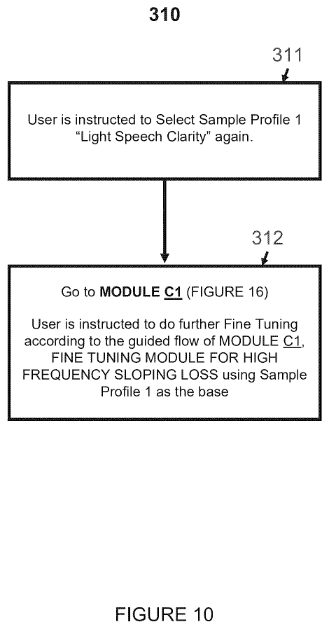

Based on the user's indicated preference, Module B1 may proceed to either 287 or 288. For example, if the user indicates a preference for sample profile 1, the technique may proceed to 288 and the technique outlined in FIG. 10. If the user indicates a preference for sample profile 2, the technique may proceed to 287 and the technique outlined in FIG. 9.

FIG. 8B illustrates graphical user interfaces (GUIs) for selecting user profiles, in accordance with certain embodiments. FIG. 8B illustrates GUI 289A, where a user may toggle to select a baseline profile, and GUI 289B, which provides a plurality of different baseline profiles for a user to select.

FIG. 9 may illustrate a continuation of the technique performed by the processor if the user indicates a preference for sample profile 2 over sample profile 1. In such a situation, the user may crave even more improvement (e.g., prefer an even more aggressive hearing profile with more enhancement in the high frequencies, from 1000 Hz to 8000 Hz). Therefore, the user should compare sample profile 2 to sample profile 3, which may have more aggressive parameter settings for the high frequencies than sample profile 2.

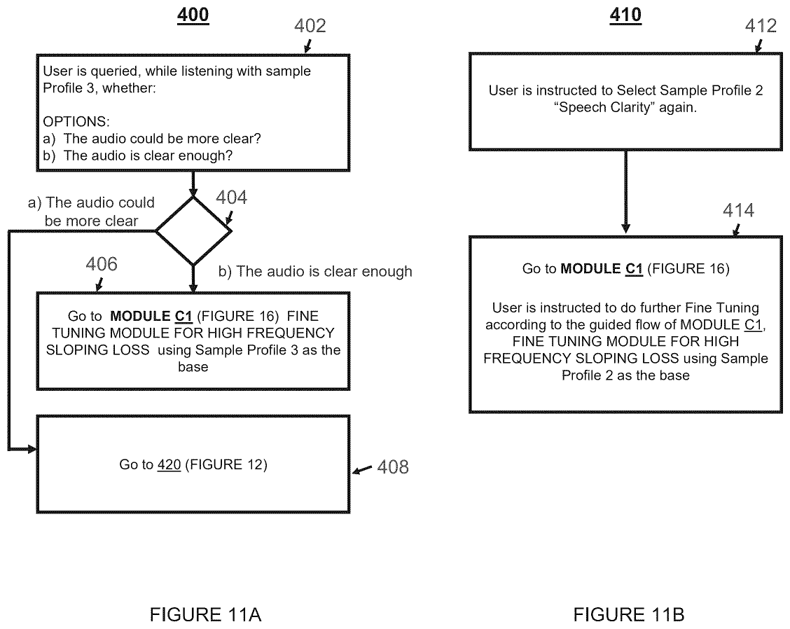

Accordingly, playback is continuously performed in 301 and the user is instructed to select sample profile 3 “Enhanced Speech Clarity” and listen to the audio through that profile for 10-15 seconds in 302. The user is then advised they may toggle between sample profile 3 and sample profile 2 in 303 and queried as to which is preferable in 304. Based on the user's preference for either sample profile 3 or sample profile 2, the technique may proceed to either 306 (FIG. 11A) or 307 (FIG. 11B), respectively.

In certain embodiments, an indication that sample profile 3 is clearer or okay may provide to 306 while an indication that sample profile 3 is too shrill or sharp may proceed to 307.

In FIG. 10, if the user indicates that sample profile 1 is better than sample profile 2, then that likely means sample profile 2 is too shrill or sharp. This would correspond to the user experiencing amplification in the high frequencies while using sample profile 2, which is stronger than needed, and which results in a distorted, disagreeable, or even painful signal. This implies the user's aural physiology (whether cochlear hair cells or other mechanism) are sufficiently sensitive to lesser stimulation, and that the sound that is sent to the brain provides enough of a clear, understandable signal in the high frequencies that no additional power is required for the user's brain to perceive it correctly. It is clear in this case that the user has no worse than mild hearing loss in the high frequencies. The user is accordingly instructed to select sample profile 1, in 311, as the baseline for further fine tuning of individual parameters and macro-parameters. The technique then proceeds to Module C1 in 312.

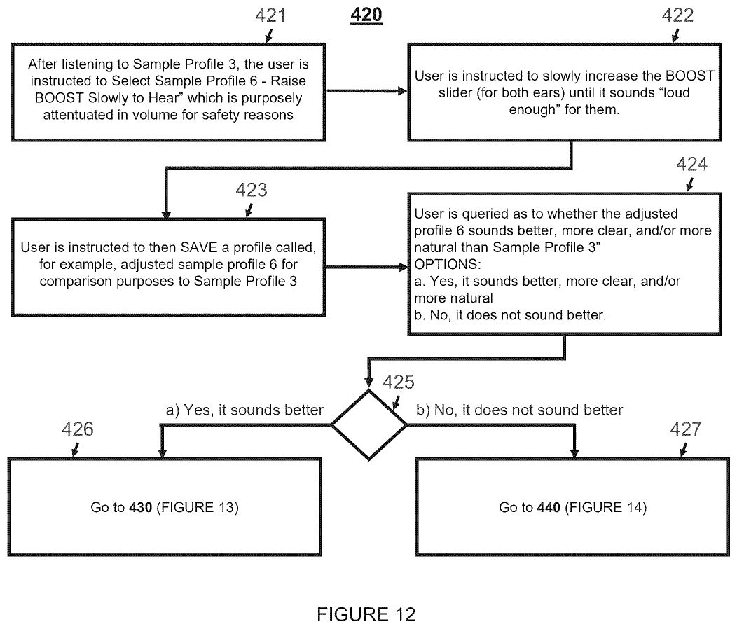

If, in FIG. 9, the user indicates a preference for either sample profile 3, technique 400 of FIG. 11A may be utilized. The user is then queried, in 402, while listening with sample Profile 3, whether (a) The audio could be more clear, or (b) The audio is clear enough. If the user, in 404 desires even greater clarity than sample profile 3, which works for light-moderate to moderate hearing loss provides, then they are directed to try sample profile 6 in FIG. 12, which is for moderately severe to severe hearing loss. Otherwise, the technique may proceed to 406 and Module C1.

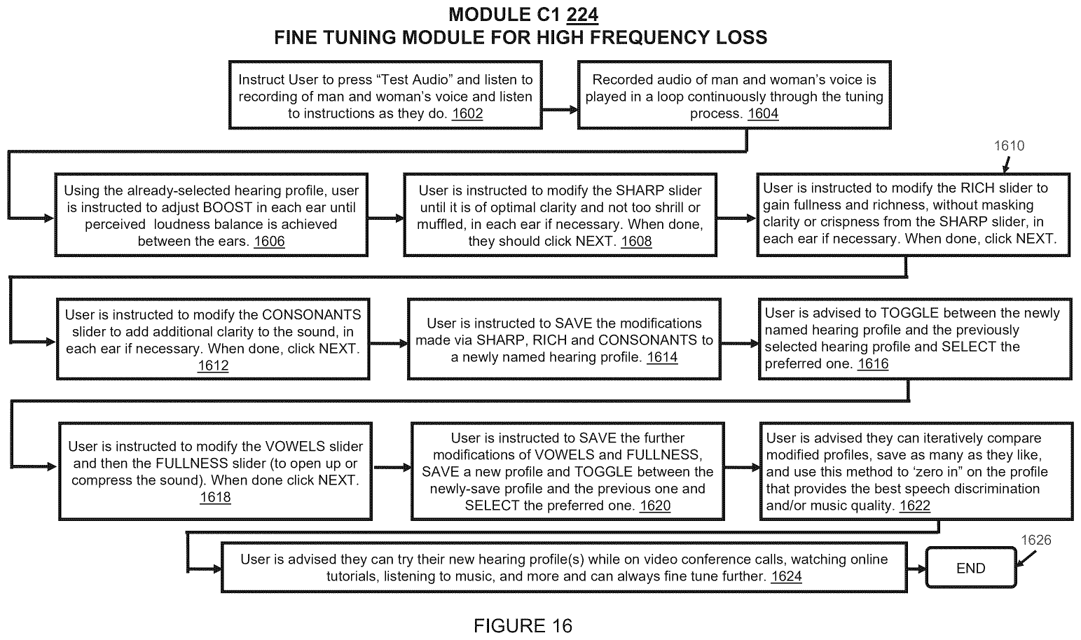

If, in FIG. 9, the user indicates a preference for either sample profile 2, technique 410 of FIG. 11B may be utilized. In 412, the user is instructed to select sample profile 2 again. The technique then proceeds to Module C1 in 414 and the user is instructed to continue on with the Fine-Tuning Module corresponding to sample profile 2, in FIG. 16.

In FIG. 12, given that the user liked sample profile 3 but craved even stronger clarity or crispness to the sound in 400 (FIG. 11), the user is directed to select sample profile 6. The shape of the response curve of sample profile 6 features a greater delta between low and high frequency regions, corresponding to a more steeply sloping loss with severe loss in the high frequencies.

Curve shape is typically more important than power across the entire spectrum when it comes to providing good speech intelligibility. Those with more steeply sloping hearing loss who retain good neural response to sound require a carefully and more precisely sculpted hearing curve than those with flatter loss for efficacious results.

Because the signal in the high frequencies in sample profile 6 is quite strong, it is important keep the user's hearing safe from sudden loud signals. Therefore, in 421, the output gain of the signal in the filter-bank is intentionally reduced when a user first selects sample profile 6. In order to restore the intended output gain of the profile, the user, in 422, is instructed to “raise BOOST slowly to hear” so that the user has fine control over the rate at which the overall curve is translated upwards. The user is instructed to raise the boost to the user's preferred level, per the user's preference.

Once the user has raised the boost to the preferred level, the user is instructed to then save the profile, in 423. The saved profile is at the level that sounds right to the user (e.g., comfortable, not too loud, not too soft). This allows isolation of clarity as the object of true comparison (e.g., allows the processor to do a comparison of only clarity related aspects between sample profile 3 and the adjusted and saved sample profile 6) and, thus, removing loudness from the equation. If for example, the profiles were not equally “comfortably loud,” the user might incorrectly choose the louder profile as the “better” one, which might not necessarily be the clearest/most efficacious for good speech understanding. A goal of the techniques described herein is to remove the corrupting influence of loudness from the true comparison.

In 424, the technique queries the user as to whether the adjusted sample profile 6 sounds better, more clear, more natural, or otherwise more preferable than sample profile 3. If the user indicates, in 425, that adjusted sample profile 6 is more preferable, the technique proceeds to 426. Otherwise, the technique may proceed to 427.

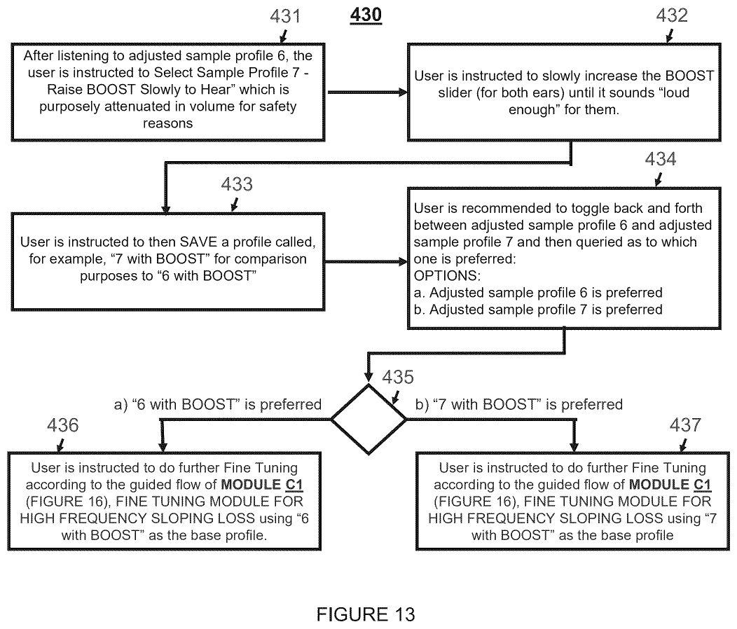

If the technique of FIG. 12 proceeds to FIG. 13 and the user implies that adjusted sample profile 6 is superior than sample profile 3, then this directionality implies it would be valuable to do an A/B comparison with one more profiles (e.g., sample profile 7). The adjustment technique of FIG. 12 may be repeated in 431 to 434 (equivalent to 421 to 424 with sample profile 7).

Sample profile 7 may provide an even stronger delta, with more gain, than sample profile 6, and contain more aggressive compression threshold values in the low frequencies in order to “squeeze” the dynamic range in the low frequencies while at the same time providing extreme gain in the high frequencies. This configuration may be especially useful for extremely steeply sloping severe hearing loss. Listeners with this type of loss often have lower tolerance for the loudness of low frequency sounds than for high frequency sounds, but need extreme gain in the high frequencies. The combination of strong compression in the low pitches with extreme gain in the highs helps more accurately target a response useful for improved speech discrimination for users with this type of hearing loss. Comparing adjusted sample profile 6 to adjusted sample profile 7 may allow for a fair comparison about clarity, as opposed to volume, to obtain the best “ballpark” result. Overall volume can always be added later when needed. The curve shape is what's important to isolate to optimize for speech understanding.

As the signal in the high frequencies in sample profile 7 may be even stronger than in sample profile 6, it is important keep the user's hearing safe from sudden loud signals. Therefore, the processor intentionally reduces the output gain of the signal in the filter-bank when a user first clicks on it. In order to restore the intended output gain of the profile, the user is instructed to “raise BOOST slowly to hear” so that the user can control the rate at which the overall curve is translated upwards. The user thus raises the boost to the optimum level of their preference.

If the user indicates, in 435, a preference for adjusted profile 6, the technique may proceed to 436 and further fine tuning of adjusted profile 6 with Module C1. Otherwise, the technique may proceed to 437 and further fine tuning of adjusted profile 7 with Module C1.

If the user indicates in FIG. 12 that adjusted sample profile 6 is not superior sample profile 3, the processor may be configured to direct the user, in 442, to select sample profile 3 and is sent to Module C1 “Fine Tuning Module for High Frequency Loss” (in FIG. 16), in 444, using sample profile 3 as the baseline profile for further fine tuning.

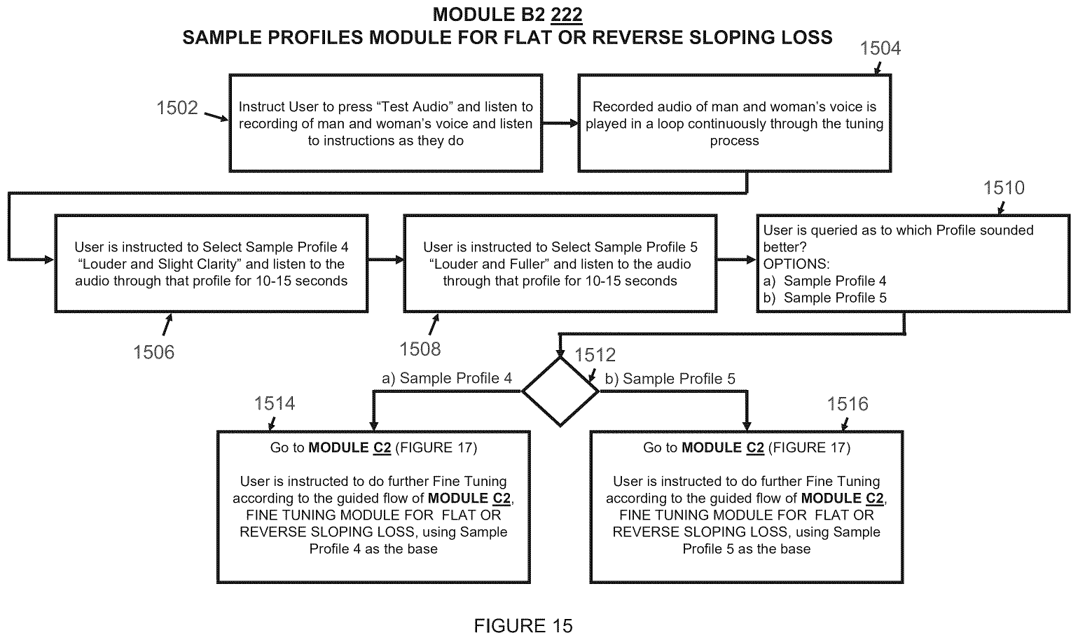

FIG. 15 illustrates Module B2, Sample Profiles Module for Flat or Reverse Sloping Loss. Based on the user's responses in FIG. 6, about whether the user knows that the user has low pitch or flat loss, or if they answered no to both clarifying questions 210 in 271, that the user does not have trouble with women's or children's voices nor with TV dialogue, while answering yes to being willing to share that they have hearing loss, then they are more likely to suffer from a flat loss across all frequencies, or a low-frequency loss, and thus the processor accesses Module B2 of the Sample Profiles Step-through Module.

In FIGS. 15, 1502 and 1504 may be similar to similar techniques described herein. Instead of compensating for gain deficiencies in low frequencies, as very low frequency boost does not help that well with speech understanding, the current technique includes a combination of spectrum wide gain plus more nuanced and subtle high-frequency enhancement in sample profiles 4 and 5. The user is instructed to listen to sample profile 4 in 1506 and sample profile 5 in 1508.

The user is then queried as to the user's preference between sample profiles 4 (“Louder and Slight Clarity”) and 5 (“Louder and Fuller”) in 1510. Based on the user response in 1512 (e.g., via a GUI or other user interface) as to the user's preference, the technique may proceed to 1514 (fine tuning sample profile 4 with Module C2 if preference for sample profile 4 is indicated) or 1516 (fine tuning sample profile 5 with Module C2 if preference for sample profile 5 is indicated).

FIG. 16 illustrates Module C1, Fine Tuning Module for High Frequency Loss. Module C1 is a configuration of the user device that allows a user to optimize, in a more granular and specific way, their listening preferences (e.g., by modifying parameters for more precise profile results). Module C1 allows tuning for, for example, sample profiles 1, 2, 3, 6, and 7, which are sample profiles that address different degrees and different speech response curve shapes of high frequency loss.

In FIGS. 16, 1602 and 1604 may be similar to similar techniques described herein. A perceived boost of 3 decibels occurs in the brain when sound is received in both ears simultaneously. This is referred to as “binaural summation.” Binaural summation can provide added benefit to the listener with hearing loss without requiring actual additional signal gain, since it is a neural perception. Consequently, it is an important aspect of this heuristic to enable the user to find an overall loudness balance between left and right ear before further fine tuning in order to leverage this neuro-acoustic effect. If the brain does not perceive that left and right ear is balanced, it will automatically “favor” one over the other, thus potentially foregoing the natural benefit of binaural summation.

In various embodiments, the systems and techniques described herein may proceed according to the order shown in the figures. Such techniques may provide for predictable processes and results. In other embodiments, the techniques may utilize alternative orders, such as orders different from that shown in the figures.

In 1606, using the already-selected hearing profile, the user is instructed to adjust boost in each ear until perceived loudness balance is achieved between the ears. Such a copy may include the message: “First, please adjust BOOST for Left and Right Ear separately, until the sound level is balanced in each ear.” A visual bendy yellow arrow pointing to the “BOOST” slider in the GUI may accompany the message.

1608 to 1620 may then allow for tuning other parameters. In 1608, “SHARP” control is tuned. “SHARP control may include a particular umbrella of frequencies from 1500 Hertz to 24,000 Hertz. The frequencies are provided in a manner where the frequencies dynamically change as the single “macro” slider control is adjusted. Thus, certain frequencies are raised or lowered at a greater rate than other frequencies when the slider is moved, with an eye towards maximizing crispness in the sibilant range such as “S's”, “F's”, Th's″ SH's. These phonemes provide critical information for speech discrimination.

After the user obtains a psychoacoustic preference for the sibilants-just sharp enough, not too shrill, not too muffled, they are directed to manipulate “RICH” control in 1610. “RICH” control may tune a low frequency envelope of frequencies from below the lowest pitches of human speech all the way past middle “C” on the piano (b, z, m, j). Hearing aid wearers often complain that while they can get adequate speech understanding from hearing aids, they sound “tinny”, “robotic”, or “electronic”, and “not natural.” “RICH” tuning (e.g., via the “RICH” tuning slider on the GUI) restores some of the naturalism and organic fidelity of the sound.

“RICH” tuning provides naturalism without masking the crispness from the “SHARP” tuning. Hence, “RICH” tuning should be performed after “SHARP” tuning. Manipulation of “RICH” first may result in a user finding the naturalistic “bed” of sound pleasing, raising it further than it needs to be raised, and then discovering themselves “chasing” crispness, by raising “SHARP” and then raising “RICH” more, in an ineffective feedback loop leading to a negative impact on speech understanding. Such a technique may result in sharpness and richness sliders raised so high that they would potentially compete with each other and cause negative artifacts such as general clipping-based distortion, and distortion from harmonic overtones.

By contrast, adjusting “SHARP” first allows for a happy medium where the high frequencies are “just sharp enough” without being too shrill to allow for crisp understanding of sibilants, while a bed is then provided to create a feeling of organic naturalism to the sound, which at the same time is not masking those sibilants.

In 1612, “CONSONANTS” (which include mid-to high frequency range (K, T, P, etc.) phonemes arranged in various manners) are modified, in order to add additional clarity to the sound. Consonants is tuned after sharpness and richness as, once sharpness and richness are determined, consonants typically have no problem “punching through” any degree of naturalism that's been set.

In 1614, the user is instructed to save the tuned settings to a new profile. In 1616, the user may be advised to toggle back and forth between the saved profile and the base sample profile to confirm whether the tuned profile or the base sample profile is superior.

In 1618, “VOWELS” may be modified via the GUI. The user may be guided through “VOWELS” adjustment (e.g., the sound of vowels). In certain situations, users with high frequency loss may require minimal adjustments as they can typically hear and understand vowels fairly well. As a result, the algorithm does not recommend incorporating the “VOWELS” control guidance until the user has saved the other control settings into a new profile, so as not to muddy the result of what may quite possibly already be on the road to an optimized curve shape.

After the user has adjusted “VOWELS”, the curve shape may crystallize for the user's hearing response. Accordingly, tuning of “FULLNESS” control is then advised in 1620. “FULLNESS” may be a macro parameter that translates the entire compression threshold curve at once across the entire spectrum. This enables the user to maintain the characteristic quality and shape of the compression curve while raising and lowering the level at which it “kicks in,” to provide a more pinched or more “open/full” sound. This is often useful for adding a level of speech understanding, as well as being particularly helpful for enhancing the experience of listening to music, in light of the much wider dynamic range of music compared to speech. In certain embodiments, the compression curve may be adjusted depending on detected sound input. For example, when speech is detected, more compression may be provided, whereas if music is detected, less compression may be utilized.

Also, the user may then adjust the macro parameter “COMFORT”, which modifies the input signal that gets subsequently processed through the DSP filter-bank. This is useful if the input signal fluctuates radically or if the user is switching between content with very loud signal such as an action film (e.g.: an “Avengers” film) vs a very quiet signal such as a drama (e.g.: “The Crown”).

In 1622, the GUI may instruct the user to iteratively compare the profiles. In 1625, the GUI may advise the user that the user may wish to try out their new profile on video conference calls or while watching or listening to content on their computer.

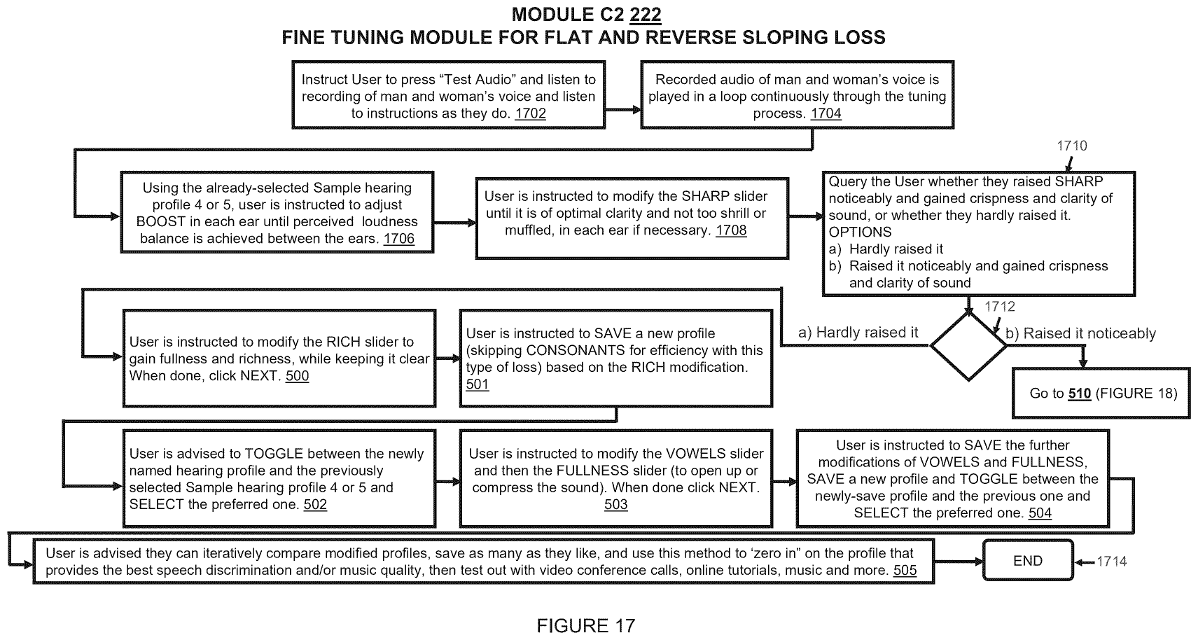

FIG. 17 illustrates Module C2, Fine Tuning Module for Flat and Reverse Sloping Loss. A user may arrive at Module C2 through one of a plurality of different pathways, such as: (1) acknowledging that the user has flat or low pitch loss up front based on self-identifying as such, or perhaps from information indicating that from a health care professional (the technique of FIG. 6 to FIG. 15, followed by Module C2); (2) the user agreeing to share that they know if they have hearing challenges, but do not have trouble with women's and children's′ voices, nor hearing from the TV, nor in restaurant background noise (FIG. 6 to FIG. 7 to FIG. 15, followed by Module C2); or (3) the user not agreeing to share whether they know if they have hearing challenges, they do not have trouble hearing women and children's′ voices, nor hearing TV, nor in restaurant background noise, and they answer a divining question about their general hearing with the option that in general they hear clearly, just not loudly enough (FIG. 6 to FIG. 7, followed by “Query User,” followed by FIG. 15, followed by Module C2).

The techniques described herein may allow for various different techniques of determining flat or reverse sloping loss, even for users that may not be comfortable sharing whether they know if they have hearing loss, or may not know. However, in certain situations, there is always a chance the user incorrectly self-identifies that they have flat or low pitch loss (or is simply not aware they have high pitch loss). In order to account for such “corner” cases, even a user who was directed through the Flat/Low Pitch Loss Sample Profile path and ends up in the Module C2 may instead be re-directed to both Module B1 and Module C1 if, through self-tuning, the algorithm determines an indication that the user would in fact obtain better benefit from operation of Modules B1 and C1.

The following provides an illustrative example. A user finds themselves on the Module B2 path, using sample profile 4 or 5 as a base profile. They are directed to adjust “SHARP” first, and they slide “SHARP” a (self-reported) “not-insignificant” amount. They are asked whether, when adjusting “SHARP” this amount, they hear voices more crisply, and they answer in the affirmative. Then they are asked to adjust “CONSONANTS” and then immediately saves a new profile. Next, they are asked to compare that newly saved profile to sample profile 3, a High Frequency Loss Sample profile. If they prefer the “character” of sample profile 3, the user may be diverted to the Module B1 pathway as this is an indication they likely have a high frequency loss that they are not aware of.

If instead, the user prefers the combination of sample profiles 4 or 5 with the fine-tuning adjustments they just made (e.g., “SHARP” and “CONSONANTS”), the user may stick with those settings as well, which still reflect a high frequency loss but with a different “character” to the sound. Essentially, the palette of solutions in the high frequency loss category “opens up,” in this case to account for these “corner cases.” For example, sample profiles 4 and 5 in Module B2 have a different compression curve shape from the Sample Profiles in Module B1, which broadens the “character” or “quality” range of sound possibility for the user with high frequency enhancement.

In FIGS. 17, 1702 and 1704 may be similar to other equivalent techniques described herein. In 1706, using the already-selected sample hearing profile 4 or 5, the user is instructed to adjust “BOOST” in each ear until perceived loudness balance is achieved between the ears. In 1708, the user is instructed to adjust “SHARP” until it is a preferred clarity and not too shrill or muffled, in each ear if necessary.

In 1710, the user is queried as to whether they raised “SHARP” noticeably and gained crispness and clarity of sound, or whether they hardly raised it (e.g., raised it less than 5%, 10%, 25%, or 50%). Options for response may include (A) Hardly raised it; and (B) Raised it noticeably and gained crispness and clarity of sound.

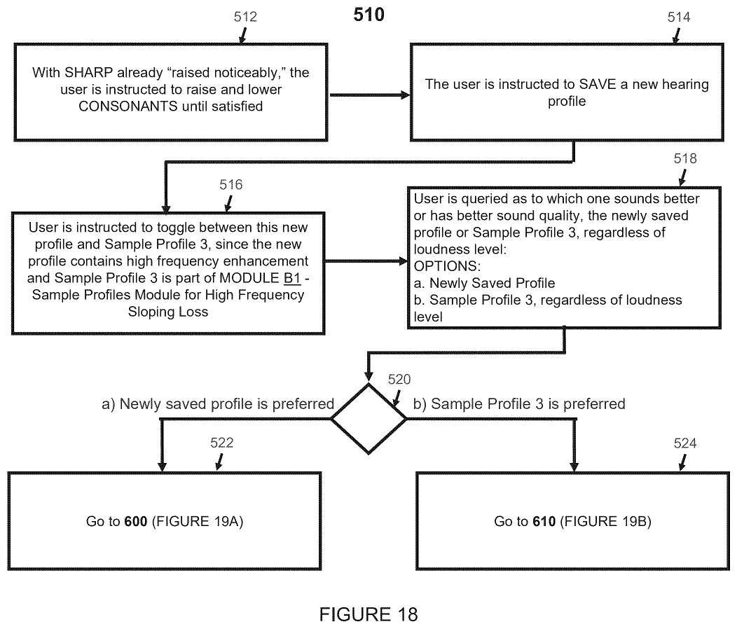

Based on the user response in 1712, the technique may proceed to 500 if the user answers with “A” and may proceed to 510 if the user answers with “B”. Accordingly, if the user indicates that they hardly raised “SHARP”, the user may be directed to continue down the standard path for Fine Tuning Module C2 (400). If the user indicates that they raised “SHARP” noticeably, they are taken to “CONSONANTS”, in 510 (of FIG. 18) in an attempt to tease out confirming evidence that that they may in fact benefit from the Fine-Tuning Module High Frequency Loss pathway instead.

In 500, the user is instructed to adjust “RICH” to gain fullness and richness, while keeping sound quality clear. The user may be instructed to save a new profile in 501 based on the “RICH” modification. In 503, the user may be advised to toggle between the various profiles (e.g., newly saved profile and previously selected profile) and select the preferred profile.

In certain embodiments, the technique of Module C2 may not request that the user adjust “CONSONANTS” in Fine Tuning Module C1, because the relative satisfaction with the fairly flat curve presented as indicated by minimal adjustment in Sharp accompanied by whatever adjustment in Rich, which is a low frequency parameter, indicates the user likely does not have high frequency loss. Other embodiments may request that the user adjust “CONSONANTS” or are free to adjust “CONSONANTS” at another point of the technique.

Otherwise, if the user is satisfied, the technique may adjust the “VOWELS” slider, which occupy the low-to-mid frequencies on the spectrum, and then the “FULLNESS” slider (to open up or compress the sound) in 503. In 504, the user may be instructed to save a further profile.

In various embodiments of Module C2, the user may adjust Comfort as they see fit, but in certain situations the user may be fairly close to achieving a useful hearing profile, and can make adjustments on their own based on the voice or use case. In 505, the GUI may indicate to the user that the user can iteratively compare modified profiles, save as many as they like, and use this method to zero in on the profile that provides the best speech discrimination and/or music quality, then test out with video conference calls, online tutorials, music, and more.

In FIG. 18, in 512, the user may have already raised SHARP a noticeable amount (e.g., based off of sample profiles 4 or 5, which are profiles meant for those with Flat or Low Pitch Loss). Such action may indicate that the user may have some challenges with high pitches about which they were not previously aware. Accordingly, the algorithm attempts to confirm whether the user may have challenges in the high pitches by asking the user to adjust CONSONANTS, the other parameter that addresses phonemes in the higher frequency range.

This provides the user with an additional opportunity to fine tune in tandem with the other aural characteristics specific to sample profiles 4 or 5 (which may have distinct Compression thresholds from the ones in sample profiles 1,2,3, 6 and 7) before the user decides whether they actually want to go down the path of the high pitch sample profiles. Accordingly, 510 provides additional palette of audio characteristics combinations beyond the base sample profiles, (that is to say in effect it creates several more sample profiles on the fly) without requiring the user to make more granular individual adjustments or have special knowledge of acoustic science.

In 516, the user is instructed to toggle between the new profile saved in 514 and sample profile 3, since the new saved profile contains high frequency enhancements and sample profile 3 is directed to high frequency sloping loss. In certain embodiments, sample profile 3 may be specifically tailored with high frequency loss in mind, so if the user still chooses sample profile 3 after making adjustments based on sample profiles 4 or 5, this is a strong indication that they were not aware of the nature of their hearing loss, a not uncommon phenomenon among those with hearing loss.

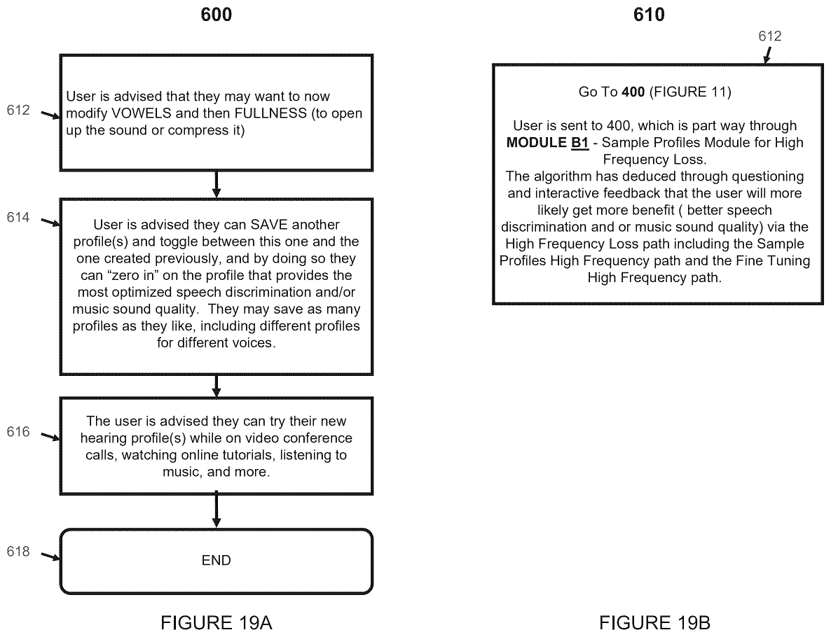

Accordingly, in 518, the user is queried as to which of the newly saved profile or sample profile 3 is better sounding or has better sound quality. If the user, in 520, indicates that the newly saved profile is preferred, the technique proceeds to 522 (FIG. 19A). If the user indicates that sample profile 3 is preferred, the technique proceeds to 524 (FIG. 19B).

In 600 of FIG. 19A, the user may have indicated that they preferred adjusted sample profile 4 or 5 that enhanced the high frequency components. This may be due to the characteristic quality of sound of the solutions in that category. This provides a “bucket” of capture for those “corner case” users who do not fall into the standard sample profile categories easily. Accordingly, in 612, the user is advised to modify VOWELS and then FULLNESS (to open up the sound or compress it).

In 614, the user is advised to save additional profile(s) and toggle between the saved profiles and the ones created previously, to determine the profile that provides the most optimized speech discrimination and/or music sound quality. The user may save as many profiles as they like, including different profiles for different voices. The user is then advised to try out the new profiles in 616.

In 610 of FIG. 19B, the user may have indicated that the user preferred sample profile 3, which may be a sample profile explicitly created for those with high frequency loss, whose compression thresholds and other parameters were optimized for that category. The user falls into a more typical tuning category, and now can be sent down the path of the Modules B1 and C1.

FIG. 20 is a block diagram illustrating an audio perception tuning system, in accordance with certain embodiments. FIG. 20 illustrates system 2000 that includes input/output 2002, audio routing mechanism 2004, audio personalization module 2006, and hearing profile databases 2008. As shown in FIG. 20, various components of FIG. 20 may be a portion of user device 2050, but it is appreciated that other arrangements of components (e.g., spread out over other devices) may be contemplated.

Input/output 2002 may be an input/output of user device 2050. Such a user device may include, for example, a smartphone, laptop, desktop, wearable device, and/or other such electronic user device. In various embodiments, input/output 2002 may include one or a plurality of interfaces configured to interact with the user. Thus, input/output 2002 may include, for example, one or more user devices that include microphones, speakers, graphical user interfaces, user input devices such as mouse, keyboard, touchscreens, audio inputs, and/or other such devices. User 2090 may utilize input/output 2002 to provide data (e.g., inputs such as voice or hand entered inputs) to system 2000, receive instructions (e.g., copies) and/or outputs (e.g., voices for tuning) from input/output 2002.

In certain embodiments, input/output 2002 may include a graphical user interface. The graphical user interface may enable a user to interact with and control the real time tuning functionality, self-tuning interface, as well as select, and save, hearing profiles. By making adjustments on the GUI (e.g., providing inputs), the user can control the audio signal at the level of granularity that is provided by the controls and functionality. For example, a control on the GUI might allow the user to change the gain of a specific frequency or collection of frequencies, or the compression of a collection of frequencies, and listen to the effect.

In certain embodiments, audio inputs from user 2090 may be routed by audio routing mechanism 2004. Audio routing mechanism 2004 may be a mechanism (e.g., software mechanism) that enables audio to be routed from input/output 2002 of a user device into audio personalization module 2006 in order to be processed, and then enables the processed audio to be routed back to input/output 2002 of the user device for output to the user. An example of audio routing mechanism 2004 is a loopback driver.

Hearing profile databases 2008 may be a database configured to store a collection of hearing profiles derived from mobile and/or online hearing tests, derived from self-tuning, from computer-based (e.g., desktop or laptop) applications with hearing tests, and/or via hearing tests presented on other devices (e.g., tablets or wearable, virtual, or augmented reality headsets, or other such devices). Hearing profile databases 2008 may include local profiles database 2024 that may be stored within a local drive of a user drive and/or cloud-based profiles database, which may reside on a cloud-based storage platform in a structured database which can be accessed via account-holders. The account-holder can view (and edit, depending on permissions status) parameter values of the profile. Parameter values include wide-dynamic range compression parameters such as gain (per frequency), compression threshold (per frequency), attack time (per frequency), release time (per frequency), ratio (per frequency), input gain, scaler, various macro-parameters that may be a combination of different parameters, output limiter parameters, and/or other such parameters.

Audio personalization module 2006 may be a tuning module that includes the modules described herein (e.g., within FIGS. 2 and 3) for audio tuning of profiles that process received audio (e.g., audio received by an electronic device such as a hearing assist device such as a hearable device, assistive listening device, mobile device, desktop or laptop, tablet, virtual reality headset, augmented reality headset, or hearing aid) to allow for hearing enhancements for a user (e.g., a user wearing the hearing assist device). In various embodiments, audio personalization module 2006 may include one or a plurality of databases, algorithms (e.g., arranged as modules), audio manipulators, and/or other such components.

Audio personalization module 2006 may include a software application for tuning according to the techniques described herein. The software application may include tuning algorithm 2010, which may perform the techniques described herein. Tuning algorithm 2010 may include the various modules described herein (e.g., Module B1, B2, C1, and C2) as certain portions of software algorithms. Such modules may be implemented as, for example, a portion of one program, different programs, from Application Programming Interfaces (APIs) and/or as other such structure.

Audio personalization module 2006 may be configured to operate on a user device (e.g., a computer or mobile device), allowing a user to route audio through the user device and audio personalization module 2006 before outputting the processed version of the audio that is personalized to the user's hearing needs or preferences, based on their selected hearing profile and real time tuning adjustments (e.g., via input/output 2002).

Audio personalization module 2006 may include sample profile database 2020. Same profile database 2020 may include data directed to a plurality of general-purpose sample profiles which cover a broad range of hearing loss/ability. The collection may be constructed from analysis of thousands of hearing profiles in hearing profile databases 2008 through selection of a distribution of audiometric configurations, and assigning values to all the parameters in the profile, including wide-dynamic range parameters, macro-parameters and output limiter parameters.

Wide-dynamic range and macro-parameters may be as described herein. Output limiter parameters may include parameters that affect the entire audio signal after it has been modified and personalized (e.g., within the main section of the DSP filter bank 2014) to the user's preferences. Output limiter parameters may then provide an additional layer of general-purpose audio processing to the audio signal in order to provide a final level of control and fidelity to the overall signal. For example, output limiter parameters may include an output limiter compression threshold (which applies to the entire signal, not individual frequency bands) which is enabled to keep the whole signal from hitting “distortion.” Other examples of output limiter parameters include output limiter attack time (for the entire signal), release time (for the entire signal), ratio (for the entire signal), and/or other such parameters.

The sample profiles in the sample profile database 2020 are automatically assigned to user accounts when a user downloads, installs, and registers for the software application associated with tuning algorithm 2010 on the user device. Consequently, once logged into the application associated with tuning algorithm 2010, the user can select any of the sample profiles from a Profile Selector user interface (an example of which is shown in FIG. 8B). When a sample profile is selected, sound being played back on the user device is processed by audio personalization module 2006 through a digital signal processing filter-bank 2014 whose parameter value settings are set according to the parameter values in the selected sample profile.

In certain embodiments, the sample profiles described herein may include profiles constructed based on analysis of thousands of hearing profiles stored within hearing profile database 2026. Such sample profiles may be constructed through selection of an optimized distribution of audiometric configurations and assigning values to all the parameters within the profile. Such parameters may include, for example, frequency-dependent dynamic range parameters, macro-parameters, and output limiter parameters. The sample profiles may, thus, be derived from data stored within a database of captured or generated hearing profiles and represent an optimized distribution of configurations, in terms of range and type of hearing loss, to accommodate for a range and different types of hearing loss.

Digital signal processing filter-bank 2014 may be configured to process an audio signal according to the configuration of the particular filter-bank as well as the input values of the filter-bank parameters. Typically, the parameter values are set by the sample profile or the hearing profile and passed to filter-bank 2014. Filter-bank 2014 may provide low latency (so that there is no perception of delayed sound on the part of the user/listener/viewer), dynamic range capabilities (so that processing can service people with a range of hearing loss), and more.

Filter-bank 2014 may provide processed audio to tuning algorithm 2010 for user 2090. Filter-bank 2014 may process such audio according to one or more parameters. An example parameter may be, for example, a compression threshold which is the determined decibel level per frequency at which user 2090 experiences discomfort when listening to a presented audio stimulus such as a pure tone. A compression threshold parameter value may be used when compressing an audio signal at the given frequency band or collection of frequencies, so that the output signal does not substantially (e.g., within 50% or less, 25% or less, 10% or less, or 0%) exceed the compression threshold at that given frequency or for that given collection of frequencies.

Furthermore, filter-bank 2014 may apply gains per decibel level per frequency to enable user 2090 to perceive/hear an audio signal at certain frequency or frequencies that user 2090 is determined to have a deficiency at.

Real time tuning mechanism 2012 may provide software capability for the software application of audio personalization module 2006. Real time tuning mechanism 2012 may be configured to respond to inputs by modifying an audio signal synchronously (in “real time”) and outputting the resultant processed signal synchronously. The user can then hear the changes to the audio signal as the inputs are being made.

Playback mechanism 2016 may be a software component of audio personalization module 2006 that allows sample or “test” audio clips to be played back (often in a loop) by the user so that the user can listen to and evaluate the effect the various hearing profiles and real time tuning adjustments are having on sound.

Audio processed by audio personalization module 2006 may be outputted by audio out 2018 to input/output 2002 of the user device. Audio out 2018 may be a software application that provides signals for audio outputs that may be converted by the hardware of the user device (e.g., speakers or headphones) to audio outputs for the user to listen.

Save profile 2022 may be a module for a user to save modified profiles, according to the techniques described herein.

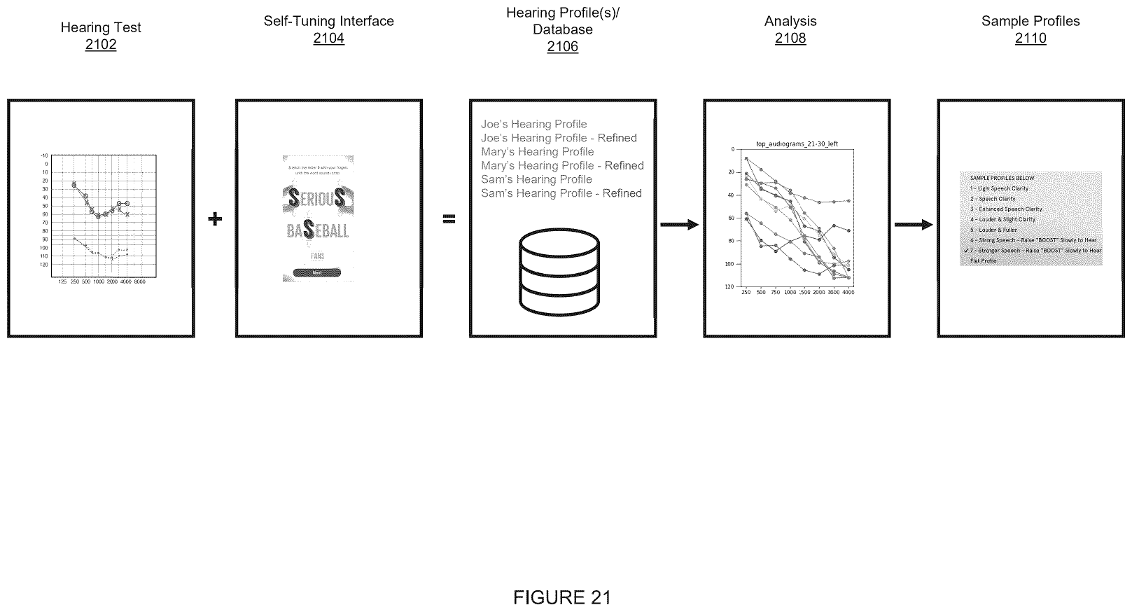

FIG. 21 is a block diagram illustrating certain aspects of an audio perception tuning system, in accordance with certain embodiments. FIG. 21 illustrates hearing test 2102, self-tuning interface 2104, hearing profile(s)/database 2106, analysis 2108, and sample profiles 2110.

Hearing test 2102 may include hearing tests that are administrated by a user device and controlled by a software application or application component that measures hearing acuity, which may include minimum threshold levels across a range of sound frequencies, along with discomfort level measurements across a range of frequencies, by providing an audio stimulus or series of stimuli that the user responds to.

Self-tuning interface 2104 may include a GUI implemented by a software application or application component on a computing device that enables a user to make real time, often granular adjustments to sound (including frequency-based adjustments) via intuitive user interface controls in order to personalize or tailor the sound for their listening preferences or hearing needs, and save the results as a hearing profile.

Hearing profile(s)/database 2106 may include the databases that includes the hearing profiles, as described herein (e.g., in FIG. 20). Analysis 2108 may include applications that include algorithms for analyzing and determining one or more profiles. Analysis 2108 may utilize techniques described within, for example, U.S. Pat. No. 9,933,990, entitled “Topological Mapping of Control Parameters”, and U.S. Pat. No. 10,506,067, entitled “Dynamic Personalization of a Communication Session in Heterogeneous Environments”, which are hereby incorporated by reference in their entirety for all purposes. Sample profiles 2110 may be the various sample (baseline) profiles described herein. In certain embodiments, analysis 2108 may generate sample profiles 2110, through domain knowledge and/or various algorithms, utilizing captured and/or generated hearing profiles stored within various databases described herein.

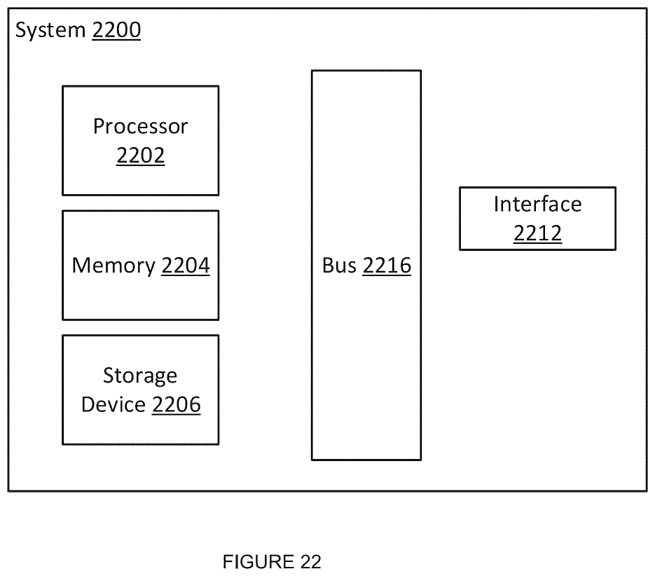

FIG. 22 illustrates a block diagram of an example computing system, in accordance with some embodiments. According to various embodiments, a system 2200 suitable for implementing embodiments described herein includes a processor 2202, a memory module 2204, a storage device 2206, an interface 2212, and a bus 2216 (e.g., a PCI bus or other interconnection fabric.) System 2200 may operate as variety of devices such as a server system such as an application server and a database server, a user device such as a laptop, desktop, smartphone, tablet, wearable device, set top box, etc., or any other device or service described herein.

Although a particular configuration is described, a variety of alternative configurations are possible. The processor 2202 may perform operations such as those described herein. Instructions for performing such operations may be embodied in the memory 2204, on one or more non-transitory computer readable media, or on some other storage device. Various specially configured devices can also be used in place of or in addition to the processor 2202. The interface 2212 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed embodiments may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

While various embodiments have been described herein, it should be understood that they have been presented by way of example only, and not limitation. For example, some techniques and mechanisms are described herein in the context of fulfillment. However, the disclosed techniques apply to a wide variety of circumstances. Particular embodiments may be implemented without some or all of the specific details described herein. In other instances, well known process operations have not been described in detail in order not to unnecessarily obscure the techniques disclosed herein. Accordingly, the breadth and scope of the present application should not be limited by any of the embodiments described herein, but should be defined only in accordance with the claims and their equivalents.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. A system comprising:
a database, configured to store a plurality of sample profiles;
an input/output device configured to receive inputs from a user and provide, at least, audible outputs to the user;
a user interface comprising a graphical user interface (GUI);
a real-time tuning mechanism;
a digital signal processing filter-bank;
a processor; and
a memory, configured to store instructions configured to cause the system to perform operations comprising:
causing the GUI to display a request for first user input;
receiving the first user input based on first user interaction with the GUI;
determining, with the processor and based on the first user input, that the user is experiencing a first hearing loss type;
selecting, from the database and based on the determination that the user is experiencing a first hearing loss type, a first sample profile to the user;
providing, with the input/output device, the first sample profile to the user;
causing the GUI to display instructions for tuning of the first sample profile;
receiving a second user input based on second user interaction with the GUI;
tuning, with the real-time tuning mechanism, the first sample profile based on the second user interaction;
processing, with the digital signal processing filter-bank and according to the tuned first sample profile processed by the real-time tuning mechanism, audio for output to the user; and
causing the input/output device to provide the tuned audio.

2. The system of claim 1, wherein the second user input comprises a modification of a macro parameter by the user.

3. The system of claim 2, wherein the tuning comprises, in response to the modification of the macro parameter by the user, adjustment of:
equalization levels for one or more frequency bands;
compression threshold values for one or more frequency bands;
attack time and/or release time values for one or more frequency bands;
ratio values for one or more frequency bands;
an input gain value; and/or
output gain values.

4. The system of claim 1, wherein the first hearing loss type is high frequency sloping hearing loss.

5. The system of claim 4, wherein the operations further comprise:
selecting and providing, based on the determination that the user is experiencing the high frequency sloping hearing loss, a second sample profile to the user;
causing the GUI to display a request for indication of preference between the first sample profile and the second sample profile; and
receiving user feedback indicating a preference for the first sample profile.

6. The system of claim 5, wherein the operations further comprise:
selecting and providing, based on the user feedback indicating the preference for the first sample profile, a third sample profile to the user;
causing the GUI to display a request for indication of preference between the first sample profile and the third sample profile; and
receiving user feedback indicating a preference for the first sample profile.

7. The system of claim 1, wherein the first hearing loss type is flat or reverse-sloping hearing loss.

8. The system of claim 7, wherein the tuning the first sample profile comprises:
adjusting a boost amount of the first sample profile;
adjusting a sharp amount of the first sample profile;
causing the GUI to display a request for indication of a sharp adjustment amount; and
receiving a third user input indicating the sharp adjustment amount.

9. The system of claim 8, wherein the third user input indicates that the sharp adjustment amount is 50% or less, and wherein the tuning the first sample profile further comprises:
adjusting a rich amount.

10. The system of claim 8, wherein the third user input indicates that the sharp adjustment amount is 50% or more, and wherein the operations further comprise:
determining, based on the tuning of the first sample profile, that the user has high frequency sloping hearing loss.

11. A method comprising:
causing a user interface comprising a graphical user interface (GUI) to display a request for first user input;
receiving the first user input based on first user interaction with the GUI;
determining, with a processor and based on the first user input, that the user is experiencing a first hearing loss type;
selecting, from a database and based on the determination that the user is experiencing a first hearing loss type, a first sample profile to the user;
providing, with an input/output device, the first sample profile to the user;
causing the GUI to display instructions for tuning of the first sample profile;
receiving a second user input based on second user interaction with the GUI;
tuning, with a real-time tuning mechanism, the first sample profile based on the second user interaction;
processing, with a digital signal processing filter-bank and according to the tuned first sample profile processed by the real-time tuning mechanism, audio for output to the user; and
causing the input/output device to provide the tuned audio.

12. The method of claim 11, wherein the second user input comprises a modification of a macro parameter by the user.

13. The method of claim 12, wherein the tuning comprises, in response to the modification of the macro parameter by the user, adjustment of:
equalization levels for one or more frequency bands;
compression threshold values for one or more frequency bands;
attack time and/or release time values for one or more frequency bands;
ratio values for one or more frequency bands;
an input gain value; and/or
output gain values.

14. The method of claim 11, wherein the first hearing loss type is high frequency sloping hearing loss.

15. The method of claim 14, further comprising:
selecting and providing, based on the determination that the user is experiencing the high frequency sloping hearing loss, a second sample profile to the user;
causing the GUI to display a request for indication of preference between the first sample profile and the second sample profile; and
receiving user feedback indicating a preference for the first sample profile.

16. The method of claim 15, further comprising:
selecting and providing, based on the user feedback indicating the preference for the first sample profile, a third sample profile to the user;
causing the GUI to display a request for indication of preference between the first sample profile and the third sample profile; and
receiving user feedback indicating a preference for the first sample profile.

17. The method of claim 11, wherein the first hearing loss type is flat or reverse-sloping hearing loss.

18. The method of claim 17, wherein the tuning the first sample profile comprises:
adjusting a boost amount of the first sample profile;
adjusting a sharp amount of the first sample profile;
causing the GUI to display a request for indication of a sharp adjustment amount; and
receiving a third user input indicating the sharp adjustment amount.

19. The method of claim 18, wherein the third user input indicates that the sharp adjustment amount is 50% or less, and wherein the tuning the first sample profile further comprises:
adjusting a rich amount.

20. The method of claim 18, wherein the third user input indicates that the sharp adjustment amount is 50% or more, and further comprising:
determining, based on the tuning of the first sample profile, that the user has high frequency sloping hearing loss.
